(19) United States
(12) Patent Application Publication
(10) Pub. No.: US 2011/0307746 A1
(43) Pub. Date: Dec. 15, 2011

(54) Systems and Methods for Intelligent and Flexible Management and Monitoring of Computer Systems

(76) Inventors: Jason A. Sullivan, Youngstown, OH (US); Charles Abdouch, (US)

(21) Appl. No.: 13/154,436

(22) Filed: Jun. 6, 2011

Related U.S. Application Data
(60) Provisional application No. 61/352,362, filed on Jun. 7, 2010.
(60) Provisional application No. 61/352,357, filed on Jun. 7, 2010.
(60) Provisional application No. 61/352,381, filed on Jun. 7, 2010.
(60) Provisional application No. 61/352,379, filed on Jun. 7, 2010.

(51) Int. Cl. G06F 11/07

(52) U.S. Cl. 714/57; 714/E11.029; 714/E11.024; 714/E11.025

(57) ABSTRACT

Systems and methods for intelligent and flexible management and monitoring of computer systems are provided using platform management controllers (PMCs) located on circuit boards of a computer system. The PMCs provide for enhanced circuit board certification and security, enhanced systems monitoring and reporting, and enhanced systems control. The PMCs also allow for emulation of processor-based devices and are low-power, low-cost and very fast when compared to the devices replaced and functionality provided. A power supply tracking apparatus helps to ensure that a first power input to an operational circuit maintains a predefined relationship to a second power input to the operational circuit. Systems and methods for receiving computer systems diagnostics information and for customizably displaying such information from a diagnostics monitoring device are incorporated into a computer system. The monitored computer system information is transmitted to a diagnostics device, such as by infrared or by a novel temporary wired connection.

### CROSS-REFERENCE TO RELATED APPLICATIONS

This application claims the benefit of U.S. Provisional Application No. 61/352,362, filed Jun. 7, 2010 and titled “Systems and Methods for Intelligent and Flexible Management and Monitoring of Computer Systems,” U.S. Provisional Application No. 61/352,357, filed Jun. 7, 2010 and titled “Tracking Apparatus,” U.S. Provisional Application No. 61/352,381, filed Jun. 7, 2010 and titled “Systems and Methods for Wirelessly Receiving Computer System Diagnostics Information,” and U.S. Provisional Application No. 61/352,379, filed Jun. 7, 2010 and titled “Systems and Methods for Providing Connectivity,” and hereby incorporates by reference each of the foregoing provisional applications by reference in their entireties for all they disclose. Additionally, this application incorporates by reference in their entireties for all they disclose each of the further applications and patents incorporated by reference in the referenced provisional applications.

### BACKGROUND OF THE INVENTION

1. Field of the Invention

The present invention relates to systems and methods for intelligent and flexible management and monitoring of computer systems, and more particularly to systems and methods that flexibly monitor and manage computer system operation and transmit and receive information regarding computer system operation for external use.

2. Background and Related Art

Computer systems have grown increasingly complex with a variety of results of this increasing complexity. One result of the increasing complexity is that it has become more difficult to diagnose problems in the computer systems as they arise. It has also become more difficult to correctly manage the computer systems in ways that prevent problems with one portion of the computer system from leading to damage or problems with other portions of the computer system.

Problems with computer systems, including problems that may require diagnosis, may arise at any time during their lifetime, and the likelihood of problems has only increased with the complexity of the computer systems. A variety of problems may initially arise at the time of manufacture. Such problems should be properly detected at the time of manufacture, or the manufacturer may risk customer unhappiness and even customer loss. Other problems arise later, during use of the computer systems, and may reduce or completely impair functionality of the computer systems. Current methods for detecting and addressing problems with computer systems both at the time of manufacture and during use of the computer systems are inadequate.

Another difficulty caused by the evolution and complexity of computer systems is a result of obsolescence of certain aspects of computer technology. As certain aspects of the computer technology become obsolete, it becomes difficult to determine how best to deal with older aspects of the computer technology. Because of the complexity of the computer systems, it can be difficult to even remove obsolete technology from the computer systems without causing significant unintended problems to the computer system. Therefore, obsolete and unused technologies remain in computer systems and the operating systems thereof simply because the work involved in safely removing the technologies is not deemed justified. Sadly, results of the failure to adequately address obsolete technology include slower-operating computer systems and systems that are unnecessarily more costly.

The difficulties discussed above may be further exacerbated in embedded systems that may be located in locations distant from traditional resources for diagnosing and addressing computer problems. As the need for embedded systems increases, the need for mechanisms to address such problems will only increase. Accordingly, it would be an improvement in the art to augment or even replace current techniques with other techniques.

Electronics systems, and in particular computer systems, have become ubiquitous. In order to function, electronics systems require input power. Electronic systems often include a power supply, which converts raw input power (e.g., alternating current supplied from commercial mains) into necessary internal supply voltages (e.g., direct current voltages such as 5 volts, 3.3. volts, etc.) within the system.

Power consumption within electronic systems has become a consideration, as increased power consumption leads to increased heat and operating expense. Accordingly, there have been efforts to reduce power consumption in many electronics systems. One technique for reducing power consumption is to use lower voltages. For example, the use of 5 volt supplies for digital logic systems was the standard for many years. Trends have been to use lower voltages, such as 3.3 volts, 2.5, volts, and even 1.8 volts. The use of lower voltages, in addition to reducing power consumption, has also provided additional benefits.

In some cases, electronic circuitry (e.g., in an integrated circuit) requires multiple voltages to operate properly. For example, some integrated circuits use relatively low voltages (e.g., 1.8 volts) to power internal circuitry, while input/output circuitry operates at a higher voltage (e.g., 3.3 volts). Some integrated circuits can use a combination of two or more different voltages.

Unfortunately, integrated circuits which require multiple voltages often place a number of rules or constraints on the relative values of the voltages. Such constraints can apply during the power up or power down sequencing. Unfortunately, power supplies tend to ramp up over a finite period of time, and thus it can be difficult to ensure that such constraints are maintained during power up or power down. Violation of power constraints can result in incorrect operation (e.g., due to latch-up) or even failure of integrated circuits (e.g., due to over current through improperly forward-biased junctions).

As a specific example, consider a device which operates using both 3.3 volts and 1.8 volts and requires (1) that the 3.3 volt power input must always be higher than the 1.8 volt power input, and (2) that the 3.3 volt power input can never be more than 2.1 volts higher than the 1.8 volt power input. If the 3.3 volt power input ramps up too slowly, it can lag behind the 1.8 volt power input and violate the first requirement. Conversely, if the 3.3 volt power input ramps up too quickly, it can get too far ahead of the 1.8 volt power input and violate the second requirement.

Maintaining required constraints can be even more difficult when a failure occurs. For example, in a system which has multiple power supplies generating multiple voltages, failure of one supply can result in simultaneous or serial violation of several constraints.

Some integrated circuit manufacturers have provided so-called “reference” designs that control sequencing of power supplies to ensure some of the constraints are met. Some reference designs, however, fail to ensure that the constraints are met in all possible operating scenarios. Moreover, most reference designs are not optimized for manufacturing environments. Typically, the reference designs include a large number of components, require a large amount of board area, and are relatively complex to debug. Moreover, in some instances, the reference designs require that additional integrated circuits be purchased from the same integrated circuit manufacturer.

It has been the inventors' experience that the most common type of failure in electronic computer systems is failure in the power supplies. In an electronics system (e.g., a computer system) which requires multiple power supplies, failure of one supply can result in violation of power constraints for some integrated circuits within the system. This can cause failures of integrated circuits, and even cause a cascade of failures. Accordingly, it would be an improvement in the art to augment or even replace current techniques with other techniques.

Printed circuit boards (PCB) are a key component of the foundation upon which many computer logic systems, as well as other electrical devices, are built. During the manufacturing process, PCBs may be programmed, debugged or otherwise communicated with to transmit or receive data. To facilitate a constant connection between the PCB and associated devices during this process, PCBs often have a tab which can later be snapped off or otherwise removed such that the PCB can be conveniently installed in a larger computer or electrical system. Prior to removal, however, the tab is used to facilitate a semi-permanent connection between the PCB and associated external manufacturing devices to facilitate programming and debugging. Alternatively, the PCB may be programmed, debugged or otherwise communicated with via complex automated devices, which electrically contact numerous locations on the PCB simultaneously. In production, programming connectors are typically not included on the PCB to reduce the cost of the PCB and since many end-users do not program the PCB further in the field.

Following the initial manufacturing process, however, it is sometimes desirable to temporarily connect to a PCB in order to communicate with the PCB for any number of purposes or reasons. For example, it may be desirable to communicate with the PCB to upload additional or alternative programming, to further debug the PCB, to diagnose and/or repair the PCB or to otherwise communicate with the PCB to transmit or receive data associated with the PCB. However, following removal of the tab as discussed above and in the absence of sophisticated automation it is difficult to temporarily connect with and thereby communicate with the PCB directly. As result, various ports or other electronic connectors are often soldered onto the PCB such that external devices can conveniently connect to the PCB via appropriate wires and corresponding connectors at the PCB's ports or electrical connectors. For example, a PCB port or connector may be a standard electrical “male” component and a device intended to connect to the PCB may be outfitted with a wire having a corresponding standard “female” component or collar thereon (or vice-versa). As the “female” collar mates with the “male” component the PCB may be effectively contacted and communicated with.

While outfitting a PCB with various ports and connectors works to facilitate temporary communication between the PCB and other external devices, the ports or connectors, which are soldered to the PCB, are generally left behind after the desired connection is completed. This results in increased costs. This cost is exacerbated by the fact that multiple ports or connectors are often required to facilitate connections for variable purposes—often resulting in multiple ports/connectors being left behind. Further, in the increasingly small computing and electrical devices common to modern technology, it is often undesirable to have bulky or space-consuming ports/connectors retained on a given PCB once installed in an associated device. However, removal of the ports/connectors can result in damage to the PCB and likewise diminishes the convenience with which the PCB can subsequently be connected to in the field for further programming, debugging and the like if necessary or desirable at a later time.

Assuming the PCB's ports/connectors are left intact, there are additional drawbacks. In complex or sophisticated PCBs it can often be onerous and difficult to locate and/or mate with the appropriate port or connector to accomplish a particular purpose. Further, if an end user desires to connect to the PCB, the associated wiring and corresponding connector necessarily result in additional costs to the user. Such costs can be substantial. Further, if the user damages either the PCB port/connector or the corresponding wiring or connector in attempting to mate them, this can result in additional costs. Ultimately, under current techniques the costs associated with connecting to a PCB after the manufacturing process is complete include, at a minimum, two connectors: one on the PCB and the other on the wiring. If the user makes any mistakes, the costs simply escalate.

### SUMMARY OF THE INVENTION

Implementation of the invention provides systems and methods for intelligent and flexible management and monitoring of a variety of aspects of computer systems and computer system operation. Implementations of the invention are applicable to a wide variety of existing and future computer systems, including a wide variety of general-purpose computer systems and a wide variety of special-purpose computer systems. One class or configuration of computer system in which the invention may be implemented in a variety of ways is disclosed in U.S. Pat. No. 7,256,991 titled Non-Peripherals Processing Control Module Having Improved Heat Dissipating Properties, U.S. Pat. No. 7,242,574 titled Robust Customizable Computer Processing System, and U.S. Pat. No. 7,075,784 titled Systems and Methods for Providing a Dynamically Modular Processing Unit, and all U.S. applications related thereto, which are expressly incorporated herein by reference for all they disclose.

In a computer system configured to have and use a plurality of interconnected circuit boards, certain implementations of the invention provide a system for ensuring that only certified circuit boards are used in the computer system. The system includes a certification chip located on each of the circuit boards. Each certification chip includes 1) key functionality necessary for the computer to function and for the circuit board on which the certification chip is located to function and 2) certification functionality communicating that the circuit board has been tested and certified to function properly in the computer system. The system also includes a certification communications bus allowing each of the certification chips to communicate with each other to verify a certified status of each circuit board incorporated into the system. In at least some such systems, each certification chip is configured to prevent the computer system from functioning if a circuit board lacking the certification chip is attached to the computer system.

In certain implementations, each certification chip is configured to monitor conditions on its respective circuit board. The certification chips may keep a record of monitored conditions on the circuit boards, and each certification chip may be configured to transmit reports of conditions on its respective circuit board.

In some implementations, wherein each certification chip is configured to intelligently participate in power control for the computer system, the certification chips collaboratively participate in timing of turning on and off a plurality of power supplies for the computer system. In some such implementations, the certification chips jointly prevent the existence of power conditions in the computer system that are known to risk destruction of chips of the computer system by sequentially turning power supplies of the computer on in a chip-safe order and only after verifying that all power supplies previous in a sequential order have properly turned on. Additionally or alternatively, the certification chips jointly prevent the existence of power conditions in the computer system that are known to risk destruction of chips of the computer system by quickly turning off power supplies that may cause damage to chips if left on upon detection of a power supply failure in the computer system.

In at least some implementations, the certification chips comprise logic gates configured to monitor power control and control activation and deactivation of the power supplies, whereby upon failure of a power supply deactivation of other power supplies is sufficiently fast to prevent damage to the computer system. In at least some implementations, deactivation of other power supplies occurs within several to a few clock cycles.

As implemented, the certification chips may operate at any time the computer system is connected to power, even if the computer system is turned off. The certification chips perform sideband management of the computer systems, and may do so using only logic gates.

In certain implementations, failure events are detected and recorded by logic gates within the certification chips, whereupon the certification chips are configured to cooperatively log the failure events and shut down the computer system. The certification chips may be configured to transmit a record of the failure events on one or more of a next power-on attempt, and at the time of failure.

In some implementations, the certification chips are configured to snoop on communications occurring on one or more busses of the computer system when the computer system is running, such as an inter-integrated circuit (I²C) bus, and a low pin count (LPC) bus. The certification chips may be configured to respond to snooped communications, such as input/output (I/O) communications and post codes.

In implementations of the invention, one or more of the certification chips is configured to provide real-time processor emulation using logic gates. The one or more certification chips providing real-time processor emulation may automatically and rapidly provide specific selected outputs for selected inputs. In certain instances, the one or more certification chips provide emulation of one of a keyboard controller and a video controller.

In certain implementations, the certification chips are configured so that when power is initially connected to the computer system, the certification chips provide communications to each other to ensure each is active and ready to function before allowing the computer system to be turned on and used.

Certain implementations occur in a computer system, wherein a system for providing integrated sideband management of the computer system is provided using a sideband management device that is integrated into the computer system and that provides sideband management of the computer system using only logic gates. The sideband management device may provide power-on management that ensures proper sequencing of activation of power supplies of the computer system on power-up. The sideband management device may ensure that activation of power supplies only occurs in a way that prevents improper, potentially-damaging, voltage combinations from occurring in the computer system. The sideband management device may be configured to interrupt power supply sequencing, turn off the computer system, and log details of a fault condition when one or more power supplies fails to activate.

A sideband management device of certain implementations may include a plurality of devices distributed across multiple circuit boards of the computer system. Regardless, the sideband management device may remain powered when the computer system is turned off. In certain implementations, the computer system is a single computer device and the sideband management device is integrated into at least one circuit board of the computer device, whereby the sideband management device does not include a separate processor or computer device.

Implementation of the invention provides a method for controlling activation of power supplies in a computer system comprising a plurality of power supplies of different voltages necessary for functioning of the computer system. The method includes selectively instructing activation of one or more of the plurality of power supplies and monitoring whether the power supply or supplies instructed to be activated properly turned on. When one or more of the power supplies that was instructed to be activated fails to properly turn on within a set time, the method includes logging a failure event and turning the computer system off.

In some implementations of the method, power supplies are activated in a sequence designed to prevent damage to components of the computer system caused by improper voltage sequences and activation of each power supply is monitored for proper activation before the sequence of activation is continued. In at least some implementations, turning the computer system off includes deactivating any power supplies that are on in an order that prevents damage to components of the computer system caused by improper voltage sequences.

Implementation of the invention provides a power management system for a computer system having a plurality of circuit boards. The power management system includes a power management bus that extends across the circuit boards of the computer system and a plurality of platform management controllers communicatively coupled to the power management bus, wherein each platform management controller is located on a different circuit board and is configured to control power supplies on its respective circuit board.

In at least some implementations, each platform management controller is implemented entirely in logic gates. The platform management controllers may be configured to operate at any time the computer system is connected to an input power source, regardless of whether the computer is turned on. The platform management controllers may also be configured to ensure that the other platform management controllers are active before allowing any power supplies of the computer system to be activated. The platform management controllers may determine that the other platform management controllers are active by generating controller-specific keys that are passed to the other controllers and passed on by the other controllers as received when the other controllers are active using the power management bus, whereby when each controller receives its own key back it knows that all controllers are active.

Implementation of the invention provides a system for emulating a processor-based computer component in a computer system while improving speed of the computer system. The system for emulating a processor-based computer component includes a logic-gate-based device configured to emulate a processor-based computer component using only logic gates, wherein the logic gates are configured to receive a set of commands normally handled by the processor-based computer component and to provide output that would normally be output by the processor-based computer component but at a much faster speed. In some implementations, the logic gates are configured to recognize and respond to only a subset of all possible commands that would normally be handled by the processor-based computer component. The logic-gate-based device may provide emulation of a legacy computer device not actively used by the computer system but the presence of which is required for proper operation of one of 1) a basic input/output system (BIOS) of the computer system and 2) an operating system (OS) of the computer system.

Certain implementations of the invention provide a method for encoding, transmitting, and decoding digital communications wherein data portions of a communication inherently include checksum information concerning the validity of received data portions without requiring extra data bits. The method includes encoding information into a digital stream using a scheme wherein certain patterns of digital data are invalid and transmitting the digital stream repeatedly using a transmitter. A receiver receives received information, and the received information is evaluated for valid and invalid patterns. The received information is only kept and decoded when a valid start pattern is followed by one or more valid data patterns.

The start pattern may include information regarding the type of data included in the data stream. The start pattern may also include information regarding the number of times the digital stream has been repeated.

Implementation of the invention provides a method for monitoring startup and function of a computer system using a platform management controller integrated into the computer system. The method includes providing a platform management controller in a computer system, wherein the platform management controller is connected to the computer system so as to be able to manage power of the computer system and obtain information from the computer system regarding function of the computer system, and wherein the platform management controller is operatively connected to a transmitter. The method also includes using the platform management controller to monitor startup and operation of the computer system, using the platform management controller to log events related to at least one of the startup and operation of the computer system, and using the platform management controller to transmit logged events using the transmitter.

The logged events may include post codes generated by the computer system on startup. When the logged events include post codes, the platform management controller may transmit the post codes at the time of startup. The logged events may additionally or alternatively include a temperature reading obtained from the computer system at one of a shutdown time and a time of a detected abnormal temperature. In some implementations, an operating system of the computer system is configured to direct messages to the platform management controller for external transmission.

Implementation of the present invention relates to techniques for providing a power supply tracking apparatus. In particular, at least some implementations of the present invention relate to a power supply tracking apparatus for ensuring that a first power input to an operational circuit maintains a predefined relationship to a second power input to the operational circuit.

Implementation of the present invention includes a power supply tracking apparatus having a reference voltage source, a comparator, and a switch. The reference voltage source provides a reference voltage to a first input of the comparator. A second input of the comparator is coupled to a first power input. An output of the comparator switches state as a function of the relative voltage of the reference voltage and the first power input. The output of the comparator controls a switch, and thus opens and closes the switch according to the relative voltage of the reference voltage and the first power input. The switch is disposed between a power supply and the second power input. Accordingly, the second power input can be maintained in a predefined relationship to the first power input.

While the methods and processes of implementations of the present invention have proven to be particularly useful in the area of personal computing enterprises, those skilled in the art will appreciate that the methods and processes of the present invention can be used in a variety of different applications and in a variety of different areas of manufacture to yield customizable enterprises, including enterprises for any industry utilizing control systems or smart-interface systems and/or enterprises that benefit from the implementation of such devices. Examples of such industries include, but are not limited to, automotive industries, avionic industries, hydraulic control industries, auto/video control industries, telecommunications industries, medical industries, special application industries, and electronic consumer device industries. Accordingly, the systems and methods of the present invention can provide benefits to many different markets, including markets that have traditionally been untapped by current computer techniques.

Implementation of the invention provides systems and methods for wirelessly receiving computer systems diagnostics information and for customizably displaying such information. The information may be received from a wide variety of existing and future computer systems, including a wide variety of general-purpose computer systems and a wide variety of special-purpose computer systems. As disclosed herein, a platform management controller (PMC) or similar device incorporated into a computer system monitors computer system information and transmits or otherwise conveys the monitored information, such as by infrared. Embodiments of the invention receive the transmitted information so it can be used for a variety of purposes such as disclosed herein.

In implementations of the invention, a plurality of logged events transmitted by the PMC or other similar device may be received and monitored by a diagnostics device such as a wireless diagnostics device. In at least some implementations of the invention, the processing features of the diagnostics device are implemented primarily or entirely in logic gates. Such implementation provides certain advantages as will be discussed in detail herein.

Implementation of the present invention relates to temporary electrical connections. In particular, the present invention relates to systems and methods for temporarily connecting an external device to a printed circuit board (PCB) in order to receive or transmit information from or to the PCB.

Implementation of the present invention takes place in association with temporary electrical connections between an external source and a PCB to facilitate the transfer of data across the connection. In at least one implementation, a temporary electrical system includes a PCB having electrical contact pads disposed adjacent one or more edges of the PCB. The electrical contact pads in turn are electrically connected to particular locations on the PCB. The systems further includes a temporary electrical connector apparatus which in turn includes an electrical wire ribbon and a head at the distal end of the electrical wire ribbon having one or more electrical contact pads disposed thereon that correspond to the electrical pads disposed on the edge(s) of the PCB.

In a further implementation, an apparatus adapted to temporarily electrically connect with a PCB includes an electrical wire ribbon. The apparatus further includes a head at the distal end of the electrical wire ribbon having one or more electrical contact pads disposed thereon. In some implementations, the head also has an adhesive disposed on it, which substantially surrounds the electrical contact pads. Prior to use, the adhesive is protected by a non-stick paper backing or the like, which can be removed upon use. In another implementation, the head includes a compression fitting that can be manipulated to tension the head such that it temporarily remains fixed to a corresponding surface, such as a PCB. In yet another implementation, the head includes pins or other locators that that can be used to facilitate a temporary connection between the head and a corresponding surface, such as a PCB. In still another implementation, the head is comprised of two opposing jaws connected by an operable spring which biases the jaws in a closed position such that the jaws can be selectively opened by a user and the head temporary “clipped” to a corresponding surface, such as a PCB. In yet another implementation, the head is comprised of two opposing stationary surfaces connectably separated the width of a PCB such that the head can be temporarily slipped over the edge of the PCB to remain temporarily affixed thereto.

While the methods and processes of implementation of the present invention have proven to be particularly useful in the area of temporary PCB connections, those skilled in the art can appreciate that the methods and processes can be used in a variety of different applications and in a variety of different areas of manufacture to yield temporary, convenient and inexpensive electrical connections.

### BRIEF DESCRIPTION OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a copy of FIG. 1 of U.S. Pat. No. 7,075,784, in which the original reference numbering has been preserved, by way of illustration of another representative computer system for use with embodiments of the invention;

FIG. 2 shows a copy of FIG. 3 of U.S. Pat. No. 7,075,784, in which the original reference number has been preserved, showing a representative circuit board configuration of a representative computer system for use with embodiments of the invention;

FIG. 3 shows a representative computer system for use with embodiments of the invention;

FIG. 4 shows a representative networked computer system for use with embodiments of the invention;

FIG. 5 shows a schematic diagram of representative connections between multiple platform management controllers;

FIG. 6 shows a schematic diagram of connections between a representative platform management controller and other devices in a computer system.

FIG. 7 illustrates a representative block diagram of an electronic system with a tracking circuit according to some embodiments of the present invention;

FIG. 8 illustrates a representative block diagram of an electronic system with a tracking circuit according to some embodiments of the present invention;

FIG. 9 illustrates a representative block diagram of a tracking circuit according to some embodiments of the present invention;

FIG. 10 illustrates a representative block diagram of a tracking circuit according to some embodiments of the present invention;

FIG. 11 illustrates a representative schematic diagram of a tracking circuit according to some embodiments of the present invention;

FIG. 12 illustrates a representative parallel arrangement of tracking circuits according to some embodiments of the present invention;

FIG. 13 illustrates a representative series arrangement of tracking circuits according to some embodiments of the present invention;

FIG. 14 illustrates a plan view of a representative PCB during the production process;

FIG. 15 illustrates a plan view of a representative PCB after production;

FIG. 16 illustrates a plan view of the top of a representative temporary electrical connection apparatus as contemplated by embodiments of the present invention;

FIG. 17 illustrates a plan view of the underside of another representative embodiment of a temporary electrical connection apparatus having adhesive thereon;

FIG. 18 illustrates a plan view of the underside of another representative embodiment of a temporary electrical connection apparatus having locators on both sides of the head;

FIG. 19 illustrates a front view of a representative embodiment similar to that of FIG. 18 having pins in the locators;

FIG. 20 illustrates a front view of a representative embodiment similar to that of FIG. 18 having pins in the locators and a compression fitting attached thereto;

FIG. 21 illustrates a side view of a representative embodiment of a temporary electrical connection apparatus having opposing biased jaws;

FIG. 22 illustrates a front view of the representative embodiment of FIG. 21;

FIG. 23 illustrates a side view of another representative embodiment of a temporary electrical connection apparatus head having two opposing stationary surfaces connectively separated the width of a PCB; and

FIG. 24 illustrates a front view of the representative embodiment of FIG. 23.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide systems and methods for intelligent and flexible management and monitoring of a variety of aspects of computer systems and computer system operation. Embodiments of the invention are applicable to a wide variety of existing and future computer systems, including a wide variety of general-purpose computer systems and a wide variety of special-purpose computer systems. One class or configuration of computer system in which the invention may be implemented in a variety of ways is disclosed in U.S. Pat. Nos. 7,256,991 titled Non-Peripherals Processing Control Module Having Improved Heat Dissipating Properties, 7,242,574 titled Robust Customizable Computer Processing System, and 7,075,784 titled Systems and Methods for Providing a Dynamically Modular Processing Unit, which are expressly incorporated herein by reference for all they disclose.

In a computer system configured to have and use a plurality of interconnected circuit boards such as that disclosed in the above-referenced patents, certain embodiments of the invention provide a system for ensuring that only certified circuit boards are used in the computer system. The system includes a certification chip located on each of the circuit boards. Each certification chip includes 1) key functionality necessary for one of the computer to function and for the circuit board on which the certification chip is located to function and 2) certification functionality communicating that the circuit board has been tested and certified to function properly in the computer system. The system also includes a certification communications bus allowing each of the certification chips to communicate with each other to verify a certified status of each circuit board incorporated into the system. In at least some such systems, each certification chip is configured to prevent the computer system from functioning if a circuit board lacking the certification chip is attached to the computer system.

In certain embodiments, each certification chip is configured to monitor conditions on its respective circuit board. The certification chips may keep a record of monitored conditions on the circuit boards, and each certification chip may be configured to transmit reports of conditions on its respective circuit board.

In some embodiments, wherein each certification chip is configured to intelligently participate in power control for the computer system, the certification chips collaboratively participate in timing of turning on and off a plurality of power supplies for the computer system. In some such embodiments, the certification chips jointly prevent the existence of power conditions in the computer system that are known to risk destruction of chips of the computer system by sequentially turning power supplies of the computer on in a chip-safe order and only after verifying that all power supplies previous in a sequential order have properly turned on. Additionally or alternatively, the certification chips jointly prevent the existence of power conditions in the computer system that are known to risk destruction of chips of the computer system by quickly turning off power supplies that may cause damage to chips if left on upon detection of a power supply failure in the computer system.

In at least some embodiments, the certification chips comprise logic gates configured to monitor power control and control activation and deactivation of the power supplies, whereby upon failure of a power supply deactivation of other power supplies is sufficiently fast to prevent damage to the computer system. In at least some embodiments, deactivation of other power supplies occurs within several to a few clock cycles.

As implemented, the certification chips may operate at any time the computer system is connected to power, even if the computer system is turned off. The certification chips perform sideband management of the computer systems, and may do so using only logic gates.

In certain embodiments, failure events are detected and recorded by logic gates within the certification chips, whereupon the certification chips are configured to cooperatively log the failure events and shut down the computer system. The certification chips may be configured to transmit a record of the failure events on one or more of a next power-on attempt, and at the time of failure.

In some embodiments, the certification chips are configured to snoop on communications occurring on one or more busses of the computer system when the computer system is running, such as an inter-integrated circuit (I²C) bus, and a low pin count (LPC) bus. The certification chips may be configured to respond to snooped communications, such as input/output (I/O) communications and post codes.

In embodiments of the invention, one or more of the certification chips is configured to provide real-time processor emulation using logic gates. The one or more certification chips providing real-time processor emulation may automatically and rapidly provide specific selected outputs for selected inputs. In certain instances, the one or more certification chips provides emulation of one of a PS/2 keyboard controller and a video controller.

In certain embodiments, the certification chips are configured so that when power is initially connected to the computer system, the certification chips provide communications to each other to ensure each is active and ready to function before allowing the computer system to be turned on and used.

Certain embodiments occur in a computer system, wherein a system for providing integrated sideband management of the computer system is provided using a sideband management device that is integrated into the computer system and that provides sideband management of the computer system using only logic gates. The sideband management device may provide power-on management that ensures proper sequencing of activation of power supplies of the computer system on power-up. The sideband management device may ensure that activation of power supplies only occurs in a way that prevents improper, potentially-damaging, voltage combinations from occurring in the computer system. The sideband management device may be configured to interrupt power supply sequencing, turn off the computer system, and log details of a fault condition when one or more power supplies fails to activate.

A sideband management device of certain embodiments may include a plurality of devices distributed across multiple circuit boards of the computer system. Regardless, the sideband management device may remain powered when the computer system is turned off. In certain embodiments, the computer system is a single computer device and the sideband management device is integrated into at least one circuit board of the computer device, whereby the sideband management device does not include a separate processor or computer device.

Embodiments of the invention provides a method for controlling activation of power supplies in a computer system comprising a plurality of power supplies of different voltages necessary for functioning of the computer system. The method includes selectively instructing activation of one or more of the plurality of power supplies and monitoring whether the power supplies instructed to be activated properly turned on. When one or more of the power supplies that was instructed to be activated fails to properly turn on within a set time, the method includes logging a failure event and turning the computer system off.

In some embodiments of the method, power supplies are activated in a sequence designed to prevent damage to components of the computer system caused by improper voltage sequences and activation of each power supply is monitored for proper activation before the sequence of activation is continued. In at least some embodiments, turning the computer system off includes deactivating any power supplies that are on in an order that prevents damage to components of the computer system caused by improper voltage sequences.

Embodiments of the invention provide a power management system for a computer system having a plurality of circuit boards. The power management system includes a power management bus that extends across the circuit boards of the computer system and a plurality of platform management controllers (PMCs) communicatively coupled to the power management bus, wherein each PMC is located on a different circuit board and is configured to control power supplies on its respective circuit board.

In at least some embodiments, each PMC is implemented entirely in logic gates. The PMCs may be configured to operate at any time the computer system is connected to an input power source, regardless of whether the computer is turned on. The PMCs may also be configured to ensure that the other PMCs are active before allowing any power supplies of the computer system to be activated. The PMCs may determine that the other PMCs are active by generating controller-specific keys that are passed to the other controllers and passed on by the other controllers as received when the other controllers are active using the power management bus, whereby when each controller receives its own key back it knows that all controllers are active.

Embodiments of the invention provide a system for emulating a processor-based computer component in a computer system while improving speed of the computer system. The system for emulating a processor-based computer component includes a logic-gate-based device configured to emulate a processor-based computer component using only logic gates, wherein the logic gates are configured to receive a set of commands normally handled by the processor-based computer component and to provide output that would normally be output by the processor-based computer component but at a much faster speed. In some embodiments, the logic gates are configured to recognize and respond to only a subset of all possible commands that would normally be handled by the processor-based computer component. The logic-gate-based device may provide emulation of a legacy computer device not actively used by the computer system but the presence of which is required for proper operation of one of 1) a basic input/output system (BIOS) of the computer system and 2) an operating system (OS) of the computer system.

Certain embodiments of the invention provide a method for encoding, transmitting, and decoding digital communications wherein data portions of a communication inherently include checksum information concerning the validity of received data portions without requiring extra data bits. The method includes encoding information into a digital stream using a scheme wherein certain patterns of digital data are invalid and transmitting the digital stream repeatedly using a transmitter. A receiver receives received information, and the received information is evaluated for valid and invalid patterns. The received information is only kept and decoded when a valid start pattern is followed by one or more valid data patterns.

The start pattern may include information regarding the type of data included in the data stream. The start pattern may also include information regarding the number of times the digital stream has been repeated.

Embodiments of the invention provide a method for monitoring startup and function of a computer system using a PMC integrated into the computer system. The method includes providing a PMC in a computer system, wherein the PMC is connected to the computer system so as to be able to manage power of the computer system and obtain information from the computer system regarding function of the computer system, and wherein the PMC is operatively connected to a transmitter. The method also includes using the PMC to monitor startup and operation of the computer system, using the PMC to log events related to at least one of the startup and operation of the computer system, and using the PMC to transmit logged events using the transmitter.

The logged events may include post codes generated by the computer system on startup. When the logged events include post codes, the PMC may transmit the post codes at the time of startup. The logged events may additionally or alternatively include a temperature reading obtained from the computer system at one of a shutdown time and a time of a detected abnormal temperature. In some embodiments, an operating system of the computer system is configured to direct messages to the PMC for external transmission.

Embodiments of the present invention relate to techniques for providing a power supply tracking apparatus. In particular, at least some embodiments of the present invention relate to a power supply tracking apparatus for ensuring that a first power input to an operational circuit maintains a predefined relationship to a second power input to the operational circuit.

Embodiments of the present invention include a power supply tracking apparatus having a reference voltage source, a comparator, and a switch. The reference voltage source provides a reference voltage to a first input of the comparator. A second input of the comparator is coupled to a first power input. An output of the comparator switches state as a function of the relative voltage of the reference voltage and the first power input. The output of the comparator controls a switch, and thus opens and closes the switch according to the relative voltage of the reference voltage and the first power input. The switch is disposed between a power supply and the second power input. Accordingly, the second power input can be maintained in a predefined relationship to the first power input.

While the methods and processes of embodiments of the present invention have proven to be particularly useful in the area of personal computing enterprises, those skilled in the art will appreciate that the methods and processes of the present invention can be used in a variety of different applications and in a variety of different areas of manufacture to yield customizable enterprises, including enterprises for any industry utilizing control systems or smart-interface systems and/or enterprises that benefit from the embodiments of such devices. Examples of such industries include, but are not limited to, automotive industries, avionic industries, hydraulic control industries, auto/video control industries, telecommunications industries, medical industries, special application industries, and electronic consumer device industries. Accordingly, the systems and methods of the present invention can provide benefits to many different markets, including markets that have traditionally been untapped by current computer techniques.

Embodiments of the invention provide systems and methods for wirelessly receiving computer systems diagnostics information and for customizably displaying such information. The information may be received from a wide variety of existing and future computer systems, including a wide variety of general-purpose computer systems and a wide variety of special-purpose computer systems. As disclosed herein a platform management controller (PMC) or similar device incorporated into a computer system monitors computer system information and transmits or otherwise conveys the monitored information, such as by infrared. Embodiments of the invention receive the transmitted information so it can be used for a variety of purposes such as disclosed herein.

In embodiments of the invention, a plurality of logged events transmitted by the PMC or other similar device may be received and monitored by a diagnostics device such as a wireless diagnostics device. In at least some embodiments of the invention, the processing features of the diagnostics device are implemented primarily or entirely in logic gates. Such embodiments provide certain advantages as will be discussed in detail herein. While certain embodiments of diagnostic devices as discussed herein are implemented using logic gate devices, it will be appreciated that the diagnostic devices may provide or pass on information to a variety of other computer systems of types currently known in the art or invented in the future. For example, in at least some embodiments, a diagnostic device may be connected to an external computer system using a wired or wireless connection such as a universal serial bus (USB) connection, an Ethernet connection, and the like. Such connection may be made at any time during use of the diagnostic device, including at the time that communications are received from the PMC or other similar device, or at some later time. Therefore, the following discussion is intended to describe computer systems that may be used with or connected to a diagnostic device for any reason.

Embodiments of the present invention relates to temporary electrical connections. In particular, the present invention relates to systems and methods for temporarily connecting an external device to a printed circuit board (PCB) in order to receive or transmit information from or to the PCB.

Embodiments of the present invention take place in association with temporary electrical connections between an external source and a PCB to facilitate the transfer of data across the connection. In at least one embodiments, a temporary electrical system includes a PCB having electrical contact pads disposed adjacent one or more edges of the PCB. The electrical contact pads in turn are electrically connected to particular locations on the PCB. The systems further includes a temporary electrical connector apparatus which in turn includes an electrical wire ribbon and a head at the distal end of the electrical wire ribbon having one or more electrical contact pads disposed thereon that correspond to the electrical pads disposed on the edge(s) of the PCB.

In further embodiments, an apparatus adapted to temporarily electrically connect with a PCB includes an electrical wire ribbon. The apparatus further includes a head at the distal end of the electrical wire ribbon having one or more electrical contact pads disposed thereon. In some embodiments, the head also has an adhesive disposed on it, which substantially surrounds the electrical contact pads. Prior to use, the adhesive is protected by a non-stick paper backing or the like, which can be removed upon use. In other embodiments, the head includes a compression fitting that can be manipulated to tension the head such that it temporarily remains fixed to a corresponding surface, such as a PCB. In yet other embodiments, the head includes pins or other locators that that can be used to facilitate a temporary connection between the head and a corresponding surface, such as a PCB. In still another embodiments, the head is comprised of two opposing jaws connected by an operable spring which biases the jaws in a closed position such that the jaws can be selectively opened by a user and the head temporary “clipped” to a corresponding surface, such as a PCB. In yet other embodiments, the head is comprised of two opposing stationary surfaces connectably separated the width of a PCB such that the head can be temporarily slipped over the edge of the PCB to remain temporarily affixed thereto.

While the methods and processes of embodiments of the present invention have proven to be particularly useful in the area of temporary PCB connections, those skilled in the art can appreciate that the methods and processes can be used in a variety of different applications and in a variety of different areas of manufacture to yield temporary, convenient and inexpensive electrical connections.

Aspects of the embodiments of the invention will be discussed using various headings for purposes of discussion and clarity. The headings are provided only by way of facilitating aspects of the illustrated embodiments, and are not intended to be limiting in any way.

### Representative Computer Systems

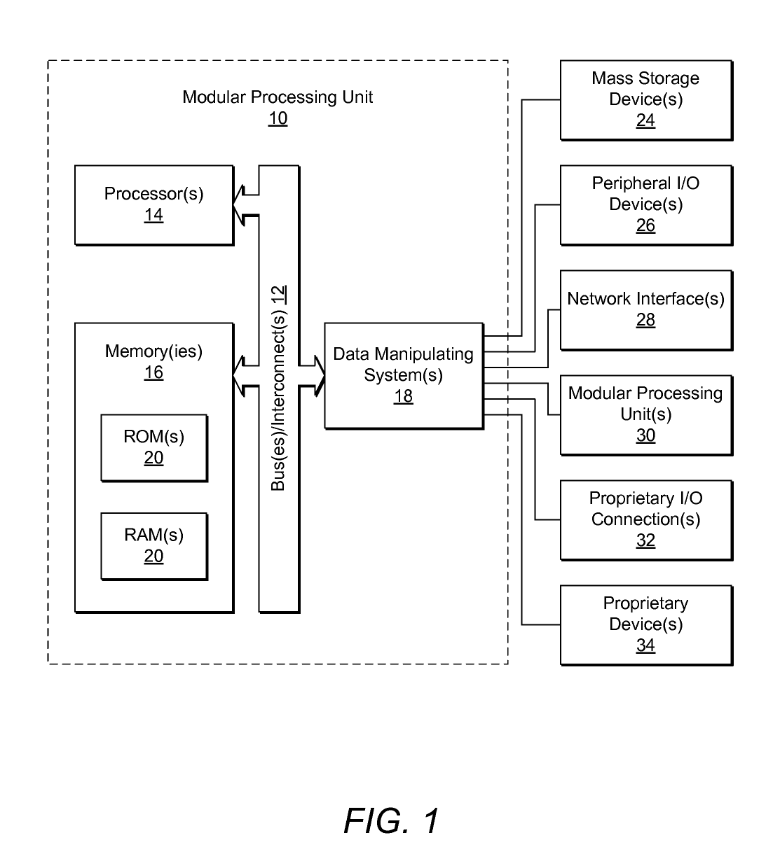

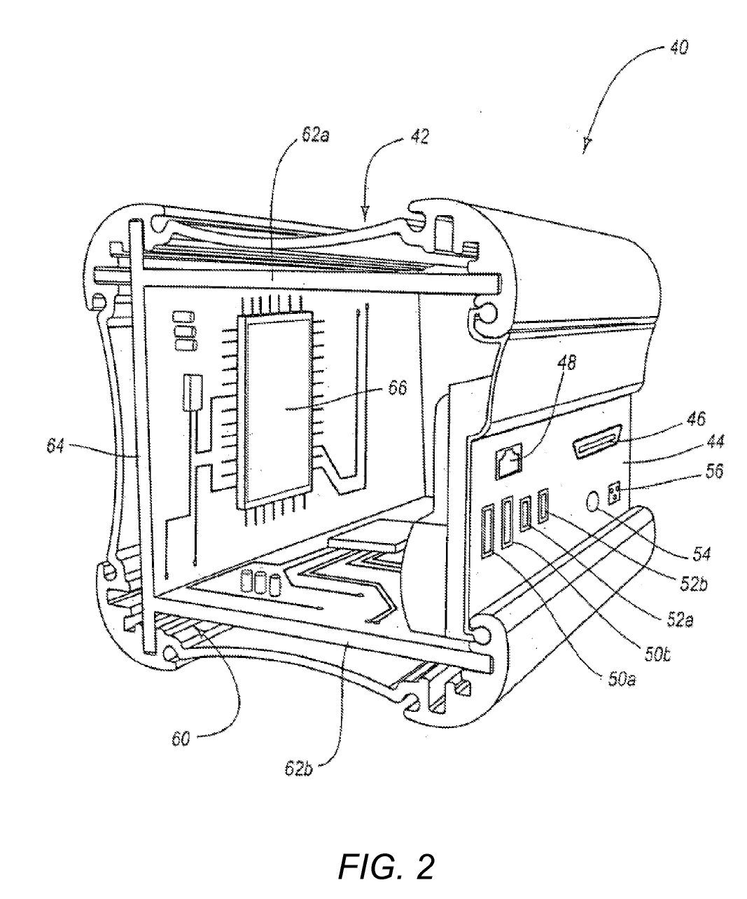

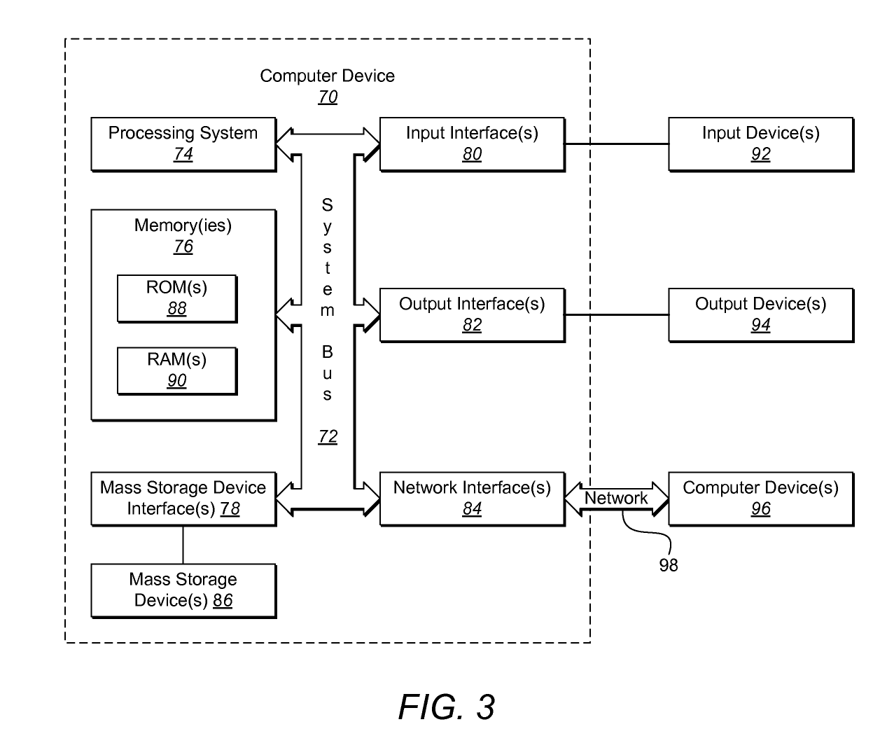

As mentioned above, embodiments of the invention may be implemented in a wide variety of computer systems and configurations, include systems and configurations similar to those disclosed in U.S. Pat. Nos. 7,256,991 titled Non-Peripherals Processing Control Module Having Improved Heat Dissipating Properties, 7,242,574 titled Robust Customizable Computer Processing System, and 7,075,784 titled Systems and Methods for Providing a Dynamically Modular Processing Unit. By way of illustration only, FIGS. 1 and 2 are copies of FIGS. 1 and 3 of U.S. Pat. No. 7,075,784 in which the original numbering has been maintained. These Figures and the corresponding discussion (which is essentially reproduced below) provide a first example of a representative computer system that may provide an operating embodiment in which at least certain embodiments of the invention may be implemented, as follows:

FIG. 1 and the corresponding discussion are intended to provide a general description of a suitable operating environment in accordance with embodiments of the present invention. As will be further discussed below, embodiments of the present invention embrace the use of one or more dynamically modular processing units in a variety of customizable enterprise configurations, including in a networked or combination configuration, as will be discussed below.

Embodiments of the present invention embrace one or more computer-readable media, including non-transitory and/or tangible computer-readable media, wherein each medium may be configured to include or includes thereon data or computer executable instructions for manipulating data. The computer executable instructions include data structures, objects, programs, routines, or other program modules that may be accessed by one or more processors, such as one associated with a general-purpose modular processing unit capable of performing various different functions or one associated with a special-purpose modular processing unit capable of performing a limited number of functions.

Computer executable instructions cause the one or more processors of the enterprise to perform a particular function or group of functions and are examples of program code means for implementing steps for methods of processing. Furthermore, a particular sequence of the executable instructions provides an example of corresponding acts that may be used to implement such steps.

Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), any solid-state storage device (e.g., flash memory, smart media, etc.), or any other device or component that is capable of providing data or executable instructions that may be accessed by a processing unit.

With reference to FIG. 1, a representative enterprise includes modular processing unit 10, which may be used as a general-purpose or special-purpose processing unit. For example, modular processing unit 10 may be employed alone or with one or more similar modular processing units as a personal computer, a notebook computer, a personal digital assistant (“PDA”) or other hand-held device, a workstation, a minicomputer, a mainframe, a supercomputer, a multi-processor system, a network computer, a processor-based consumer device, a smart appliance or device, a control system, or the like. Using multiple processing units in the same enterprise provides increased processing capabilities. For example, each processing unit of an enterprise can be dedicated to a particular task or can jointly participate in distributed processing.

In FIG. 1, modular processing unit 10 includes one or more buses and/or interconnect(s) 12, which may be configured to connect various components thereof and enables data to be exchanged between two or more components. Bus(es)/interconnect(s) 12 may include one of a variety of bus structures including a memory bus, a peripheral bus, or a local bus that uses any of a variety of bus architectures. Typical components connected by bus(es)/interconnect(s) 12 include one or more processors 14 and one or more memories 16. Other components may be selectively connected to bus(es)/interconnect(s) 12 through the use of logic, one or more systems, one or more subsystems and/or one or more I/O interfaces, hereafter referred to as “data manipulating system(s) 18.” Moreover, other components may be externally connected to bus(es)/interconnect(s) 12 through the use of logic, one or more systems, one or more subsystems and/or one or more I/O interfaces, and/or may function as logic, one or more systems, one or more subsystems and/or one or more I/O interfaces, such as modular processing unit(s) 30 and/or proprietary device(s) 34. Examples of I/O interfaces include one or more mass storage device interfaces, one or more input interfaces, one or more output interfaces, and the like. Accordingly, embodiments of the present invention embrace the ability to use one or more I/O interfaces and/or the ability to change the usability of a product based on the logic or other data manipulating system employed.

The logic may be tied to an interface, part of a system, subsystem and/or used to perform a specific task. Accordingly, the logic or other data manipulating system may allow, for example, for IEEE1394 (firewire), wherein the logic or other data manipulating system is an I/O interface. Alternatively or additionally, logic or another data manipulating system may be used that allows a modular processing unit to be tied into another external system or subsystem. For example, an external system or subsystem that may or may not include a special I/O connection. Alternatively or additionally, logic or other data manipulating system may be used wherein no external I/O is associated with the logic. Embodiments of the present invention also embrace the use of specialty logic, such as for ECUs for vehicles, hydraulic control systems, etc. and/or logic that informs a processor how to control a specific piece of hardware. Moreover, those skilled in the art will appreciate that embodiments of the present invention embrace a plethora of different systems and/or configurations that utilize logic, systems, subsystems and/or I/O interfaces.

As provided above, embodiments of the present invention embrace the ability to use one or more I/O interfaces and/or the ability to change the usability of a product based on the logic or other data manipulating system employed. For example, where a modular processing unit 10 is part of a personal computing system that includes one or more I/O interfaces and logic designed for use as a desktop computer, the logic or other data manipulating system may be changed to include flash memory or logic to perform audio encoding for a music station that wants to take analog audio via two standard RCAs and broadcast them to an IP address. Accordingly, the modular processing unit 10 may be part of a system that is used as an appliance rather than a computer system due to a modification made to the data manipulating system(s) (e.g., logic, system, subsystem, I/O interface(s), etc.) on the back plane of the modular processing unit 10. Thus, a modification of the data manipulating system(s) on a back plane can change the application of the modular processing unit. Accordingly, embodiments of the present invention embrace very adaptable modular processing units 10.

As provided above, processing unit 10 includes one or more processors 14, such as a central processor and optionally one or more other processors designed to perform a particular function or task. It is typically processor 14 that executes the instructions provided on computer-readable media, such as on memory(ies) 16, a magnetic hard disk, a removable magnetic disk, a magnetic cassette, an optical disk, or from a communication connection, which may also be viewed as a computer-readable medium.

Memory(ies) 16 includes one or more computer-readable media that may be configured to include or includes thereon data or instructions for manipulating data, and may be accessed by processor(s) 14 through bus(es)/interconnect(s) 12. Memory(ies) 16 may include, for example, ROM(s) 20, used to permanently store information, and/or RAM(s) 22, used to temporarily store information. ROM(s) 20 may include a basic input/output system (“BIOS”) having one or more routines that are used to establish communication, such as during start-up of modular processing unit 10. During operation, RAM(s) 22 may include one or more program modules, such as one or more operating systems, application programs, and/or program data.

As illustrated, at least some embodiments of the present invention embrace a non-peripheral encasement, which provides a more robust processing unit that enables use of the unit in a variety of different applications. In FIG. 1, one or more mass storage device interfaces (illustrated as data manipulating system(s) 18) may be used to connect one or more mass storage devices 24 to bus(es)/interconnect(s) 12. The mass storage devices 24 are peripheral to modular processing unit 10 and allow modular processing unit 10 to retain large amounts of data. Examples of mass storage devices include hard disk drives, magnetic disk drives, tape drives, optical disk drives, and solid-state drives.

A mass storage device 24 may read from and/or write to a magnetic hard disk, a removable magnetic disk, a magnetic cassette, an optical disk, solid-state memory, or another computer-readable medium. Mass storage devices 24 and their corresponding computer-readable media provide nonvolatile storage of data and/or executable instructions that may include one or more program modules, such as an operating system, one or more application programs, other program modules, or program data. Such executable instructions are examples of program code means for implementing steps for methods disclosed herein.

Data manipulating system(s) 18 may be employed to enable data and/or instructions to be exchanged with modular processing unit 10 through one or more corresponding peripheral I/O devices 26. Examples of peripheral I/O devices 26 include input devices such as a keyboard and/or alternate input devices, such as a mouse, trackball, light pen, stylus, or other pointing device, a microphone, a joystick, a game pad, a satellite dish, a scanner, a camcorder, a digital camera, a sensor, and the like, and/or output devices such as a monitor or display screen, a speaker, a printer, a control system, and the like. Similarly, examples of data manipulating system(s) 18 coupled with specialized logic that may be used to connect the peripheral I/O devices 26 to bus(es)/interconnect(s) 12 include a serial port, a parallel port, a game port, a universal serial bus (“USB”), a firewire (IEEE 1394), a wireless receiver, a video adapter, an audio adapter, a parallel port, a wireless transmitter, any parallel or serialized I/O peripherals or another interface.

Data manipulating system(s) 18 enable an exchange of information across one or more network interfaces 28. Examples of network interfaces 28 include a connection that enables information to be exchanged between processing units, a network adapter for connection to a local area network (“LAN”) or a modem, a wireless link, or another adapter for connection to a wide area network (“WAN”), such as the Internet. Network interface 28 may be incorporated with or peripheral to modular processing unit 10, and may be associated with a LAN, a wireless network, a WAN and/or any connection between processing units.

Data manipulating system(s) 18 enable modular processing unit 10 to exchange information with one or more other local or remote modular processing units 30 or computer devices. A connection between modular processing unit 10 and modular processing unit 30 may include hardwired and/or wireless links. Accordingly, embodiments of the present invention embrace direct bus-to-bus connections. This enables the creation of a large bus system. It also eliminates hacking as currently known due to direct bus-to-bus connections of an enterprise. Furthermore, data manipulating system(s) 18 enable modular processing unit 10 to exchange information with one or more proprietary I/O connections 32 and/or one or more proprietary devices 34.

Program modules or portions thereof that are accessible to the processing unit may be stored in a remote memory storage device. Furthermore, in a networked system or combined configuration, modular processing unit 10 may participate in a distributed computing environment where functions or tasks are performed by a plurality of processing units. Alternatively, each processing unit of a combined configuration/enterprise may be dedicated to a particular task. Thus, for example, one processing unit of an enterprise may be dedicated to video data, thereby replacing a traditional video card, and providing increased processing capabilities for performing such tasks over traditional techniques.

While those skilled in the art will appreciate that embodiments of the present invention may comprise a variety of configurations, reference is made to FIG. 2, which illustrates a representative embodiment of a durable and dynamically modular processing unit. In the illustrated embodiment of FIG. 2, processing unit 40 is durable and dynamically modular. In the illustrated embodiment, unit 40 is an approximately 3½-inch (8.9 cm) cube platform that utilizes an advanced thermodynamic cooling model, eliminating any need for a cooling fan.

However, as provided herein, embodiments of the present invention embrace the use of other cooling processes in addition to or in place of a thermodynamic cooling process, such as a forced air cooling process and/or a liquid cooling process. Moreover, while the illustrated embodiment includes a 3½-inch cube platform, those skilled in the art will appreciate that embodiments of the present invention embrace the use of a modular processing unit that is greater than or less than a 3½-inch cube platform. Similarly, other embodiments embrace the use of shapes other than a cube.

Processing unit 40 also includes a layered motherboard configuration, that optimizes processing and memory ratios, and a bus architecture that enhances performance and increases both hardware and software stability. Those skilled in the art will appreciate that other embodiments of the present invention also embrace non-layered motherboards. Moreover, other embodiments of the present invention embrace embedded motherboard configurations, wherein components of the motherboard are embedded into one or more materials that provide an insulation between components and embed the components into the one or more materials, and wherein one or more of the motherboard components are mechanical, optical, electrical or electro-mechanical. Furthermore, at least some of the embodiments of embedded motherboard configurations include mechanical, optical, electrical and/or electro-mechanical components that are fixed into a three-dimensional, sterile environment. Examples of such materials include polymers, rubbers, epoxies, and/or any non-conducting embedding compound(s).

Embodiments of the present invention embrace providing processing versatility. For example, in accordance with at least some embodiments of the present invention, processing burdens are identified and then solved by selectively dedicating and/or allocating processing power. For example, a particular system is defined according to specific needs, such that dedication or allocation of processing power is controlled. Thus, one or more modular processing units may be dedicated to provide processing power to such specific needs (e.g., video, audio, one or more systems, one or more subsystems, etc.). In some embodiments, being able to provide processing power decreases the load on a central unit. Accordingly, processing power is driven to the areas needed.

While the illustrated embodiment, processing unit 40 includes a 2 GHz processor and 1.5 GB of RAM, those skilled in the art will appreciate that other embodiments of the present invention embrace the use of a faster or slower processor and/or more or less RAM. In at least some embodiments of the present invention, the speed of the processor and the amount of RAM of a processing unit depends on the nature for which the processing unit is to be used.

A highly dynamic, customizable, and interchangeable back plane 44 provides support to peripherals and vertical applications. In the illustrated embodiment, back plane 44 is selectively coupled to encasement 42 and may include one or more features, interfaces, capabilities, logic and/or components that allow unit 40 to be dynamically customizable. In the illustrated embodiment, back plane 44 includes DVI Video port 46, Ethernet port 48, USB ports 50 (50a and 50b), SATA bus ports 52 (52a and 52b), power button 54, and power port 56. Back plane 44 may also include a mechanism that electrically couples two or more modular processing units together to increase the processing capabilities of the entire system as indicated above, and to provide scaled processing as will be further disclosed below.

Those skilled in the art will appreciate that back plane 44 with its corresponding features, interfaces, capabilities, logic and/or components are representative only and that embodiments of the present invention embrace back planes having a variety of different features, interfaces, capabilities and/or components. Accordingly, a processing unit is dynamically customizable by allowing one back plane to be replaced by another back plane in order to allow a user to selectively modify the logic, features and/or capabilities of the processing unit.

Moreover, embodiments of the present invention embrace any number and/or type of logic and/or connectors to allow use of one or more modular processing units 40 in a variety of different environments. For example, the environments include vehicles (e.g., cars, trucks, motorcycles, etc.), hydraulic control systems, and other environments. The changing of data manipulating system(s) on the back plane allows for scaling vertically and/or horizontally for a variety of environments, as will be further discussed below.

Furthermore, embodiments of the present invention embrace a variety of shapes and sizes of modular processing units. For example, in FIG. 2 modular processing unit 40 is a cube that is smaller than traditional processing units for a variety of reasons.

As will be appreciated by those skilled in the art, embodiments of the present invention are easier to support than traditional techniques because of, for example, materials used, the size and/or shape, the type of logic and/or an elimination of a peripherals-based encasement.

In the illustrated embodiment, power button 54 includes three states, namely on, off and standby for power boot. When the power is turned on and received, unit 40 is instructed to load and boot an operating system supported in memory. When the power is turned off, processing control unit 40 will interrupt any ongoing processing and begin a shut down sequence that is followed by a standby state, wherein the system waits for the power on state to be activated.

USB ports 50 are configured to connect peripheral input/output devices to processing unit 40. Examples of such input or output devices include a keyboard, a mouse or trackball, a monitor, printer, another processing unit or computer device, a modem, and a camera.

SATA bus ports 52 are configured to electronically couple and support mass storage devices that are peripheral to processing unit 40. Examples of such mass storage devices include floppy disk drives, CD-ROM drives, hard drives, tape drives, and the like.

As provided above, other embodiments of the present invention embrace the use of additional ports and means for connecting peripheral devices, as will be appreciated by one of ordinary skill in the art. Therefore, the particular ports and means for connecting specifically identified and described herein are intended to be illustrative only and not limiting in any way.

As provided herein, a variety of advantages exist through the use of a non-peripheral processing unit over larger, peripheral packed computer units. By way of example, the user is able to selectively reduce the space required to accommodate the enterprise, and may still provide increased processing power by adding processing units to the system while still requiring less overall space. Moreover, since each of the processing units includes solid-state components rather than systems that are prone to breaking down, the individual units may be hidden (e.g., in a wall, in furniture, in a closet, in a decorative device such as a clock).

The durability of the individual processing units/cubes allows processing to take place in locations that were otherwise unthinkable with traditional techniques. For example, the processing units can be buried in the earth, located in water, buried in the sea, placed on the heads of drill bits that drive hundreds of feet into the earth, on unstable surfaces in furniture, etc. The potential processing locations are endless. Other advantages include a reduction in noise and heat, an ability to provide customizable “smart” technology into various devices available to consumers, such as furniture, fixtures, vehicles, structures, supports, appliances, equipment, personal items, etc.

In FIG. 2, the view illustrates processing unit 40 with the side walls of the cube removed to more fully illustrate the non-peripheral based encasement 42, cooling process (e.g., thermodynamic convection cooling, forced air, and/or liquid cooling), optimized layered circuit board configuration, and dynamic back plane 44. In the illustrated embodiment, the various boards are coupled together by using a force fit technique, which prevents accidental decoupling of the boards and enables interchangeability. The boards provide for an enhanced EMI distribution and/or chip/logic placement. Those skilled in the art will appreciate that embodiments of the present invention embrace any number of boards and/or configurations. Furthermore, board structures may be modified for a particular benefit and/or need based on one or more applications and/or features. In FIG. 2, processing unit 40 includes a layered circuit board/motherboard configuration 60 that includes two parallel sideboards 62 (62a and 62b) and a central board 64 transverse to and electronically coupling sideboards 62. While the illustrated embodiment provides a tri-board configuration, those skilled in the art will appreciate that embodiments of the present invention embrace board configurations having fewer than three boards, and layered board configurations having more than three boards. Moreover, embodiments of the present invention embrace other configurations of circuit boards, other than boards being at right angles to each other.

In the illustrated embodiment, the layered motherboard 60 is supported within encasement 42 using means for coupling motherboard 60 to encasement 42. In the illustrated embodiment, the means for coupling motherboard 60 to encasement 42 include a variety of channeled slots that are configured to selectively receive at least a portion of motherboard 60 and to hold motherboard 60 in position. As upgrades are necessary with the advancing technology, such as when processor 66 is to be replaced with an improved processor, the corresponding board (e.g., central board 64) is removed from the encasement 42 and a new board with a new processor is inserted to enable the upgrade. Accordingly, embodiments of the present invention have proven to facilitate upgrades as necessary and to provide a customizable and dynamic processing unit.

Processing unit 40 also includes one or more processors that at are configured to perform one or more tasks. In FIG. 2, the one or more processors are illustrated as processor 66, which is coupled to central board 64. As technology advances, there may be a time when the user of processing unit 40 will want to replace processor 66 with an upgraded processor. Accordingly, central board 64 may be removed from encasement 42 and a new central board having an upgraded processor may be installed and used in association with unit 40. Accordingly, embodiments of the present invention embrace dynamically customizable processing units that are easily upgraded and thus provide a platform having longevity in contrast to traditional techniques.

FIG. 3 and the corresponding discussion are intended to provide a general description of another suitable operating environment in which at least certain embodiments of the invention may be implemented. One skilled in the art will appreciate that embodiments of the invention may be practiced by one or more computing devices and in a variety of system configurations, including in a networked configuration. However, while the methods and processes of the present invention have proven to be useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible and/or non-transitory computer-readable media, and the phrases “tangible computer-readable medium” and “non-transitory computer-readable medium” (or plural variations) used herein are intended to exclude transitory propagating signals per se.

With reference to FIG. 3, a representative system for use with or to implement embodiments of the invention includes computer device 70, which may be a general-purpose or special-purpose computer or any of a variety of consumer electronic devices. For example, computer device 70 may be a personal computer, a notebook computer, a netbook, a personal digital assistant (“PDA”) or other hand-held device, a workstation, a minicomputer, a mainframe, a supercomputer, a multi-processor system, a network computer, a processor-based consumer electronic device, or the like.

Computer device 70 includes system bus 72, which may be configured to connect various components thereof and enables data to be exchanged between two or more components. System bus 72 may include one of a variety of bus structures including a memory bus or memory controller, a peripheral bus, or a local bus that uses any of a variety of bus architectures. Typical components connected by system bus 72 include processing system 74 and memory 76. Other components may include one or more mass storage device interfaces 78, input interfaces 80, output interfaces 82, and/or network interfaces 84, each of which will be discussed below.

Processing system 74 includes one or more processors, such as a central processor and optionally one or more other processors designed to perform a particular function or task. It is typically processing system 74 that executes instructions provided on computer-readable media, such as on memory 76, a magnetic hard disk, a removable magnetic disk, a magnetic cassette, an optical disk, or from a communication connection, which may also be viewed as a computer-readable medium.

Memory 76 includes one or more computer-readable media that may be configured to include or includes thereon data or instructions for manipulating data, and may be accessed by processing system 74 through system bus 72. Memory 76 may include, for example, ROM(s) 88, used to permanently store information, and/or RAM(s) 90, used to temporarily store information. ROM(s) 88 may include a basic input/output system (“BIOS”) having one or more routines that are used to establish communication, such as during start-up of computer device 70. RAM(s) 90 may include one or more program modules, such as one or more operating systems, application programs, and/or program data.

One or more mass storage device interfaces 78 may be used to connect one or more mass storage devices 86 to system bus 72. The mass storage devices 26 may be incorporated into or may be peripheral to computer device 70 and allow computer device 70 to retain large amounts of data. Optionally, one or more of the mass storage devices 86 may be removable from computer device 70. Examples of mass storage devices include hard disk drives, magnetic disk drives, tape drives, solid-state drives and optical disk drives. A mass storage device 86 may read from and/or write to a magnetic hard disk, a removable magnetic disk, a magnetic cassette, an optical disk, a solid-state device, or another computer-readable medium. Mass storage devices 86 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 80 may be employed to enable a user to enter data and/or instructions to computer device 70 through one or more corresponding input devices 92. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 80 that may be used to connect the input devices 92 to the system bus 72 include a serial port, a parallel port, a game port, a universal serial bus (“USB”), an integrated circuit, a firewire (IEEE 1394), or another interface. For example, in some embodiments input interface 80 includes an application specific integrated circuit (ASIC) that is designed for a particular application. In a further embodiment, the ASIC is embedded and connects existing circuit building blocks.

One or more output interfaces 82 may be employed to connect one or more corresponding output devices 94 to system bus 72. Examples of output devices include a monitor or display screen, a speaker, a printer, a multi-functional peripheral, and the like. A particular output device 94 may be integrated with or peripheral to computer device 70. Examples of output interfaces include a video adapter, an audio adapter, a parallel port, and the like.

One or more network interfaces 84 enable computer device 70 to exchange information with one or more other local or remote computer devices, illustrated as computer devices 96, via a network 98 that may include hardwired and/or wireless links. Examples of network interfaces include a network adapter for connection to a local area network (“LAN”) or a modem, wireless link, or other adapter for connection to a wide area network (“WAN”), such as the Internet. The network interface 84 may be incorporated with or peripheral to computer device 70. In a networked system, accessible program modules or portions thereof may be stored in a remote memory storage device. Furthermore, in a networked system computer device 70 may participate in a distributed computing environment, where functions or tasks are performed by a plurality of networked computer devices.

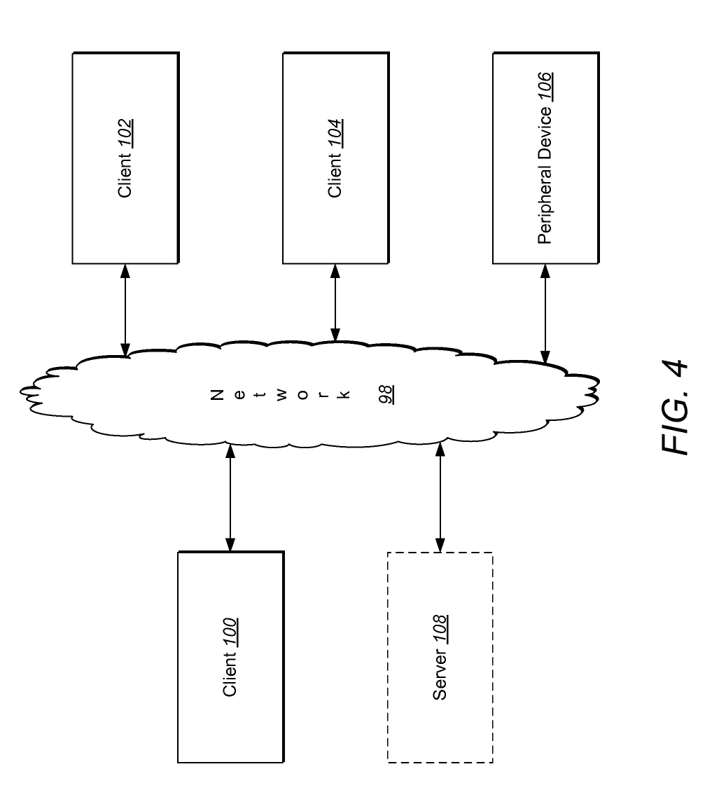

Thus, while those skilled in the art will appreciate that embodiments of the present invention may be practiced in a variety of different environments with many types of system configurations, FIG. 4 provides a representative networked system configuration that may be used in association with certain embodiments of the present invention. The representative system of FIG. 4 includes a computer device, illustrated as client 100, which is connected to one or more other computer devices (illustrated as client 102 and client 104) and one or more peripheral devices 106 (such as a multifunctional peripheral (MFP) MFP) across network 98. While FIG. 4 illustrates an embodiment that includes a client 100, two additional clients, client 102 and client 104, one peripheral device 106, and optionally a server 108, connected to network 98, alternative embodiments include more or fewer clients, more than one peripheral device, no peripheral devices, no server 108, and/or more than one server 108 connected to network 98. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

### Platform Management

The foregoing described general computer systems are representative of computer systems generally that may be used with embodiments of the invention. Aspects of embodiments of the invention will now be described in more detail with more particular reference to specific computer systems of the type disclosed in U.S. Pat. Nos. 7,256,991 titled Non-Peripherals Processing Control Module Having Improved Heat Dissipating Properties, 7,242,574 titled Robust Customizable Computer Processing System, and 7,075,784 titled Systems and Methods for Providing a Dynamically Modular Processing Unit, discussed above and incorporated herein by reference. While certain embodiments of the invention may be especially applicable to features associated with the type of computer system disclosed in the referenced patents, it should be understood that it is intended that any features of the various embodiments of the invention discussed herein that are applicable to other computer system types are intended for use with such computer system types.

The computer system disclosed in the referenced patents and discussed above with respect to FIG. 2 particularly includes several interconnected circuit boards. Embodiments of the present invention provide certification and security features to each of the connected boards. For example, in certain embodiments, it may be desirable to ensure that only licensed and certified circuit boards are used with each other. One current frustration in the computer industry occurs with respect to non-compatibilities that occur between interconnected circuit boards, especially in light of the great variety of board manufacturers. In many instances, an incompatibility between boards reflects poorly on one board manufacturer, even if that manufacturer is not at fault. Preventing the use of non-certified and/or non-licensed boards can ensure that incompatibilities do not occur, thereby improving customer satisfaction and customers' overall impression of the boards' manufacturer(s).

Therefore, embodiments of the invention provide a certification chip contained on each board. As will be discussed herein in more detail, the certification chips may be provided with additional functionality that enhances the value of the certification chip, thereby offsetting any additional costs associated with providing the certification chip on each board. One such function that will be discussed herein in more detail is power management. As such, the certification chips may be considered platform management controllers (PMCs) in such instances. In addition, as will be discussed herein in more detail, the certification chips may be logic gate chips where all functionality is provided by logic gates with the functions provided by the chips performed entirely by the logic connections of the chip. This allows the certification chips to function extremely quickly and also allows the certification chips to perform multiple functions in parallel without requiring interrupts, as will be discussed in more detail below.

In instances where certification chips are incorporated into the circuit boards, the manufacturer may perform testing to ensure that the boards are compliant with certain compatibility standards and/or are compatible with all other boards to which each board may be connected, thereby ensuring that each board containing a certification chip will simply work when it is connected to a system containing boards all containing certification chips. In addition, it may be desirable to ensure that only certified boards are used in such systems. Therefore, the systems (e.g. the certification chips) may be configured to ensure that only certified and/or licensed boards are connected to the system or the system will not function.

One way this may be done is by incorporating key functionality of the computer system into the certification chip(s). For example, as will be discussed in more detail later, many basic input/output systems (BIOSs) and operating systems (OSs) require that certain legacy components are present in the system, even if such components are no longer used by the BIOS or OS. If equivalent functionality or other needed functionality is incorporated into the certification chip(s), the system will not function when a non-certified board (one lacking the certification chip) is incorporated into the system.

An alternative way to accomplish this is to have the certification chip manage power of the computer system (as a platform management controller mentioned above and discussed in detail below). When a board lacking a certification chip is inserted into the system, needed power control functionality may be absent. Alternatively, the certification chips may communicate with each other, and even if all needed power control functionality is present, they may detect that a certification chip is lacking and may decline to provide power to the computer system. A variety of similar certification/licensing control schemes other than those specifically discussed herein is embraced by the embodiments of the invention.

In addition to certification/licensing issues, the certification chips can be used to provide security/authentication features in some embodiments, such as is commonly required for certain software packages. For example, certain software licenses restrict installation to a particular machine. The certification chips may include a unique serial number contained in the logic gates of the chips. In some embodiments, aspects of trusted platform management may be controlled using the certification chips, and may include the provision of a manufacturer/system key as well as a customer key (e.g. provided by a software license, etc.), the combination of which may permit the system to receive and decrypt a token file, thereby authenticating the authorized system to the licensed software. The serial number, manufacturer/system key, customer key, and the like may be contained in the certification chips and may be distributed across multiple chips in the computer system and is therefore resistant to duplication or theft.

In at least some embodiments of the invention, one or more platform management controllers (PMCs) (herein, reference to a singular controller and/or multiple controllers should be interpreted as referring to a single and/or multiple controllers wherever applicable for the desired computer system configuration) function to provide sideband management in a manner not previously available in the art. Previous sideband management schemes rely on a separate computer system and/or processor to manage connected computer systems. Such sideband management schemes require the separate computer system remain powered on and monitoring for situations needing additional computing power. When such a need is detected, the separate computer system/processor provides power-on signals to other computers to provide the additional computing power needed. The existing sideband managers are essentially only able to determine whether the additional computer devices successfully powered on and became available or not, and are unable to provide any details regarding any failures. Because of the cost of such systems, existing sideband mangers have been limited to server-class machines.

Embodiments of the invention provide low-cost and powerful sideband management in ways not previously available. The PMC according to embodiments of the invention is powered at any time when the computer system is connected to a power source. Some additional components of the computer system (e.g. static memory, temperature monitors, etc.) may also be provided power with or by the PMC, even when the computer is turned off. This provides additional resources to the PMC to monitor the health of the computer system, log events related to the computer system, and to communicate regarding the status of the computer system to external devices even when the computer system is not powered on or cannot power on due to a system failure.

Because the sideband management is performed using only logic, power requirements for the sideband management are extremely small. Additionally, sideband management using the PMC is greatly enhanced in management and diagnostic capabilities over existing systems. Because the relative cost of sideband management using the PMC is greatly reduced with respect to existing systems, it may be readily incorporated into systems where it has not previously been available, including desktop, laptop, and workstation systems, as well as embedded systems.

With respect to management and diagnostic capabilities, the sideband management system is able to monitor system health in much more detail than previously possible. Because the PMC is tightly integrated into the computer system being monitored and managed, great flexibility in what is managed is provided. For example, the PMC may be connected to a variety of system busses, to a variety of power supplies/power rails, to temperature measuring devices, and the like, and may record and use information from any or all of these and other sources to manage the system.

One example of this is in the area of power control. Where existing management systems generally simply turn on power to a computer system, embodiments of the invention provide for intelligent, flexible, and controlled power management. In a typical computer system, a variety of power supplies, voltages, and power rails are present. A number of computer chips in a typical system require that certain voltages be applied in a certain order or there is a risk of damage to the computer chips. Existing systems therefore provide a sequence in which various power supplies are turned on; however, there is typically no management of the sequence other than simply timing the order of activation of the power supplies. Thus, if a power supply fails in a typical system, the system still moves on to activation of other supplies, which may result in chip damage due to undesirable voltage situations.

The PMC of embodiments of the present invention intelligently activates power supplies to prevent this problem. Because various power supplies may be located on different circuit boards (see FIG. 2) control of the various power supplies may be distributed to various PMCs under the direction of a primary PMC. In embodiments of the invention, rather than simply turn the power on, the PMC instructs activation of power supplies in any necessary sequence, but only proceeding to the next step of the sequence when the PMC verifies by monitoring the power rails that each activated power supply is working properly and the desired voltages are on and proper (or are ramping on appropriately, as discussed in more detail below). When a failure is detected (e.g. a power supply fails to activate within a certain period of time), the PMC logs the failure and intelligently shuts down power by turning off any power supplies that had been activated.

In at least some embodiments, the power is also shut down (either normally or upon detection of a failure as discussed above) intelligently, in a sequence designed to prevent undesirable voltage conditions. Similarly, when a power failure of one or more power supplies occurs after normal startup, the PMC in some embodiments responds by quickly turning off all other power supplies that would result in an undesired voltage condition after failure of the failed power supply. The failure event is logged and the remaining power supplies are shut down in a protective sequence monitored and controlled by the PMC. These types of actions taken by the PMC prevent undesired voltage combinations from occurring in the system, thereby limiting or preventing damage to computer system components. Thus, in comparison to existing systems, embodiments of the PMC greatly reduce the likelihood of collateral damage to other portions of the computer system, which may greatly reduce maintenance and repair costs.

Additionally, because the PMC contains a log of the failure, a technician seeking to address the failure has a record of the exact failure and is able to know exactly which circuit, chip, or component to debug. As will be discussed in more detail below, the PMC transmits the all or part of the log of failures (and any other recorded data) at the time of failure and at a time of next power-on attempt. Because the PMC is powered even when the computer system is turned off, it can transmit all or part of the log of failures upon receiving a power-on signal before even attempting to power on the system again. Thus, even if a subsequent power-on attempt fails, the PMC conveys information regarding past failures. This information may be received by a variety of external receiving devices, such as by infrared signal or by direct electrical connection as will be discussed in more detail below.

Because the PMC is implemented entirely using logic gates, the PMC is able to rapidly respond to detected failures. For example, the PMC is able to respond (e.g. deactivate one or more power supplies) within typically a few clock cycles, further enhancing the protection provided by the PMC. The parallel processing power provided by the logic gates ensures that even when other tasks are being handled by the PMC, it is able to respond without requiring an interrupt or without being affected by other actions occurring on the computer system.

While the PMC is always on when the computer system is connected to a power source, the PMC may not remain on once the computer system is disconnected from the power source. In systems having multiple PMCs on multiple circuit boards (e.g. as in a system similar to that depicted in FIG. 2), the PMCs may be configured to ensure that all PMCs are active and functioning before attempting to take any action with respect to the computer system. To enable communication between the PMCs, one or more busses, such as a power management bus (for communicating power management information) and a secure bus (e.g. for communicating security/certification information), may be established between the PMCs.

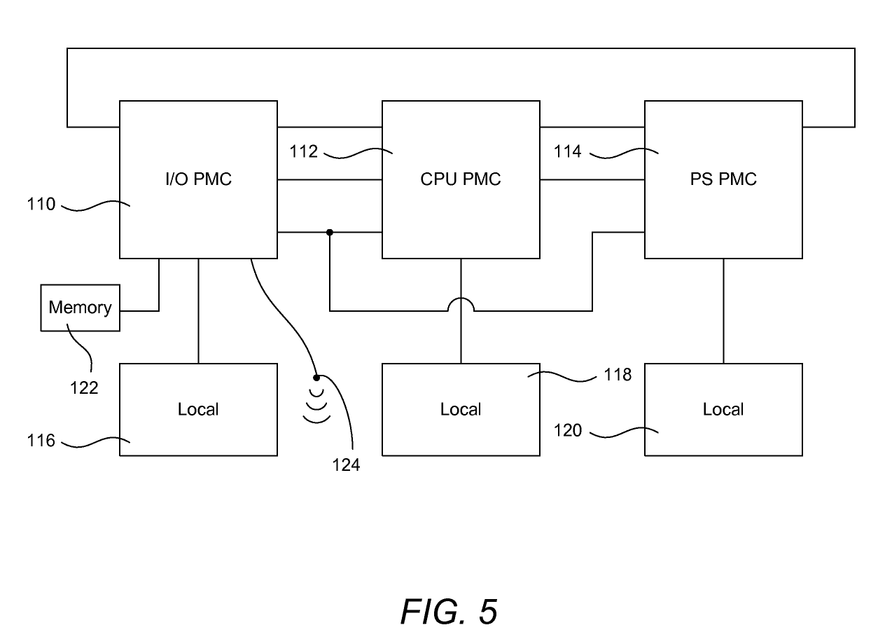

One depiction of exemplary connections between different PMCs (110, 112, 114) is shown in FIG. 5. Each PMC (110, 112, 114) has access to its own local (116, 118, 120) resources and controlled elements. In the illustrated embodiment, one PMC is the “main” PMC, and has access to memory 122 for storing log information and an infrared (IR) transmitter 124 (or other communications device) for error reporting of the log information. Each PMC (110, 112, 114) may be of a very small size and therefore takes up minimal real estate resources on the circuit boards. Additionally, the devices use very little power and may be essentially unbreakable and/or very reliable so that there is very little chance of a PMC failure.

When power is first delivered to the PMCs (e.g. a power source is connected to the computer system), each active PMC (110, 112, 114) determines whether information being communicated by the other controllers is valid information (e.g. the other controllers have had time to begin functioning properly) or is merely junk information being communicated by the other controllers during startup. There are various ways to accomplish this determination, but one way is for each controller to pass a unique key code to the other controllers in series while simultaneously passing any codes it receives on in the series. Thus, when each controller receives its own key code back, it knows that the other controllers are functioning properly, and the controllers can jointly begin their operations knowing that all future data and information between them is valid.

As mentioned above, additional functionality may be added to the PMC. Because of the evolving nature of computers, existing BIOSs and OSs commonly require input from legacy hardware devices that no longer perform useful functions for the computer. It is complex and/or difficult to remove all references to such legacy devices from the various BIOSs and OSs, so most hardware manufacturers simply continue adding these devices to their designs, at some cost and waste of circuit board real estate.

In embodiments of the invention, the PMC is used to emulate the functionality of one or more legacy devices such as a PS/2 keyboard controllers and a video controller. Such emulation is accomplished in straight logic using the logic gates of the PMC, instead of using a processor/microcontroller as is commonly done in the art. This implementation has certain advantages, especially in speed. Upon booting of the computer device, the BIOS commonly checks the video controller and the keyboard controller. In existing systems, the queries may take between one tenth and one half second. With the PMC, the queries may be answered in several to a few (e.g. up to ten) clock cycles, leading to faster boot times. Of course, if it is found that a particular BIOS requires some delay to accept the answers to be provided by the emulated controller, a delay may be added before the response is provided.

As another example, when a USB keyboard is connected to a system and a command is received from the keyboard, certain OSs query the PS/2 keyboard controller multiple times (as many as sixty times) whether the command was received from the PS/2 controller before moving on to interpret the USB keyboard command. As may be appreciated, this and similar querying may result in significant slowing of the system during use in addition to the slowness described above encountered during startup. The ability of the PMC to rapidly respond can therefore greatly reduce system latencies.

Because no actual functionality of the emulated legacy devices may be necessary for operation of the computer system other than to satisfy expectations of the BIOS or OS, full emulation of all functionality of the legacy device(s) is generally not necessary. Instead, an evaluation may be made as to which commands are issued by the BIOS/OS and which answers are expected in return, and only those commands and answers configured into the gates of the PMC. As discussed above, the parallel processing capabilities of the PMC allow the controller to respond to power management needs and device emulation needs (and any other needs) simultaneously, further enhancing overall system response speeds.

The emulation discussed above is merely one example of microprocessor or microcontroller emulation in logic. Embodiments of the invention embrace all full and partial emulations of microprocessors and microcontrollers in logic gates. Another advantage of emulation of microprocessors and microcontrollers in logic is efficiency savings as logic emulation of processing requires much less power overall.

As discussed above, the PMC can participate in management and failure diagnosis of the computer system, as well as in failure reporting. To facilitate this management and diagnosis and error reporting, the PMC is provided with access to various busses within the computer system whereby it can snoop on communications over those busses and use the busses to communicate with certain devices at times when the busses are not being otherwise used. Examples of busses to which the PMC can be connected include the low pin count (LPC) bus and the inter-integrated circuit (I²C) bus. As the PMC is able to monitor a variety of systems information, it is better able to report on detected error conditions, thereby facilitating identification of parts issues and service issues. Money is saved in repairs, redesign, and especially in rapidly pinpointing problems.

Thus, when a failure event occurs and the PMC shuts down the system, a log is formed whereby knowledge can be obtained as to the cause of the failure. Additionally, when the computer system is off, the PMC knows that the various devices connected to the LPC bus and the I²C bus are not being used by other components of the computer system, and may then communicate with such devices, as many such devices may remain active even after power-down. One such device may be a temperature sensor. Just after the time of shutdown, the PMC may query any temperature sensors to determine the operating temperature of the computer system at the time of shutdown, and may record it in an associated log in static memory accessible to the PMC after shutdown.

When the computer system is running, the PMC relies on information it obtains from the various busses and devices to which it is connected to obtain information that may be important for logging purposes. For example, while the computer system is running, the BIOS may receive temperature information from the temperature sensors. For example, some computer systems include temperature set points at which certain actions should be taken. When a first temperature set point is passed, the BIOS may know to increase temperature control efforts such as increasing cooling fan speed and reducing processor speed. When a second temperature set point is passed, the BIOS may know to gracefully shut down the OS to protect the computer and allow for cooling. When a third temperature set point is passed, the BIOS may forcefully and immediately shut down the system. The PMC logs such events by snooping on the communications between the BIOS and the temperature sensors, and further obtains a temperature reading at shutdown by communicating with the temperature sensor directly as discussed above.

When the PMC is connected to the various busses, it may be subject to a wide variety of communications, many of which require no response from the PMC. Therefore, the PMC may include logic features whereby it only examines and/or responds to certain kinds of communications on the LPC bus and the I²C bus. For example, the PMC may examine I/O and Post-code addressed communications on the LPC bus while ignoring memory cycle communications. In some instances, however, such as for system diagnostics, the PMC may be configured to snoop on all communications on the respective busses and to report on them, even if the PMC takes no other action.

Where the PMC is configured to examine only a subset of communications on the various busses to which it is attached, it may actually respond to only a subset of those it examines. For example, the PMC may examine all I/O communications but only respond to a subset of the I/O communications addressed to the legacy PS/2 keyboard controller and the legacy video controller as part of its emulation of those devices as discussed above. As another example, in instances where system monitoring occurs at startup, the PMC may monitor, examine, and even record and report on all post codes generated by the BIOS but may not respond to any of them.

As discussed below in more detail, the PMC is able to communicate to systems external to the computer system, such as by using the infrared transmitter 84 as shown in FIG. 5. An external device may include a display screen for diagnostic purposes on which a variety of messages related to the communications from the PMC may be displayed, including all monitored events and logged entries discussed herein. In addition, an OS may be programmed with information that allows it to send messages on the LPC bus that will be intercepted and understood by the PMC, which will then act by transmitting messages to the external device. This is another example of how the snooping capabilities of the PMC may be used.

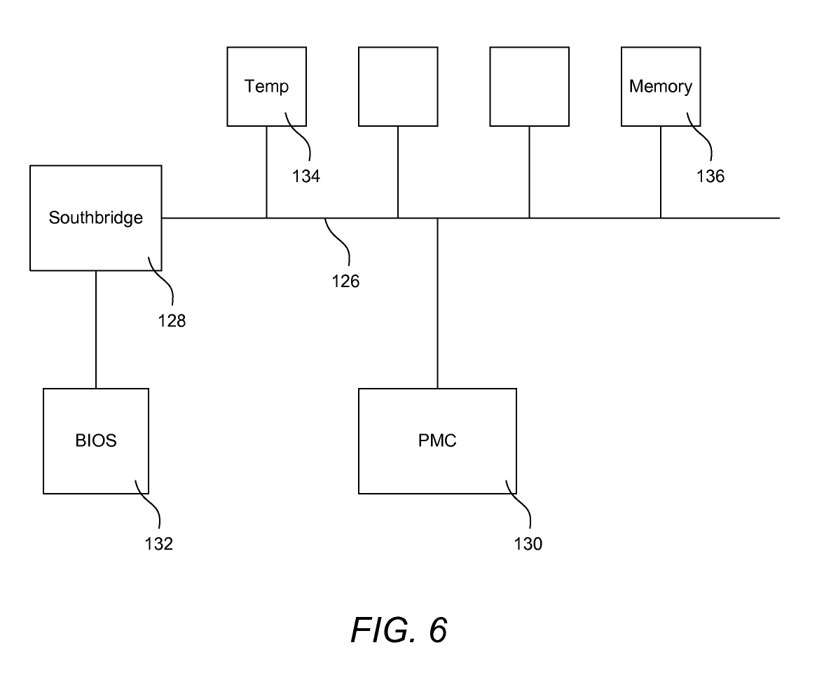

FIG. 6 shows a depiction of a partial configuration of certain components discussed herein and their relation to the I²C bus 126, which is connected to a southbridge 128 of the computer system. A PMC 130 is also connected to the I²C bus 126, and therefore is able to snoop on communications on the I²C bus 126 while the computer is on and use the I²C bus 126 to communicate when the computer is off. The southbridge 128 is also connected to a BIOS 132 as is known in the art. Various devices are connected to the I²C bus 126 in this example, including a temperature sensor 134 and a memory device 136, such as a four-kilobyte static memory device. The computer system uses approximately five hundred forty (540) bytes of this memory device for system storage purposes, as is known in the art, and virtually all computer systems utilize a memory device that is significantly larger than this amount (e.g. four kilobytes) as a smaller device does not function properly. In at least some embodiments, the PMC 130 accesses the extra storage on the memory device 136 to store its logs or event codes of recorded events. As the event log fills, the PMC 130 overwrites older entries, which are generally no longer of interest.

The temperature sensor 134 and the memory device 136 are powered by standby power when the computer system is off, and the PMC 130 is thereby able to access those devices for monitoring and logging purposes. Where a computer system includes multiple PMCs, the various PMCs pass their information to the “main” PMC as discussed above with respect to FIG. 5, and the main PMC stores any necessary log events in the memory device 136 for reporting purposes. Thus, while the various PMCs are able to report on local information and manage local conditions on their respective boards as necessary, they are organized under a main or master PMC that handles event logging and reporting and communicates with the memory device 136.

This main PMC may be considered an I/O PMC and is illustrated as PMC 110 in FIG. 5, which is connected to the IR transmitter 124. The IR transmitter 124 allows the PMC to communicate wirelessly with diagnostic systems and other external devices using a pattern of light flashes. Because the PMC 110 uses logic gates to control the IR transmitter 124, it performs any communication through the IR transmitter 124 in parallel with its other duties and is not required to stop any of its other duties while communicating externally to the computer system. Thus, power management and monitoring functions continue while the PMC 110 is communicating using the IR transmitter 124, and no microcontroller is involved.

Although a wide variety of IR transmission and communication schemes may be used by the PMC 110 and the IR transmitter 124, some implementations of the invention use select schemes that provide information and data that inherently carries checksum or validity information without requiring separate checksum or validity bits. The infrared communications scheme also includes clock information. In many instances, it is anticipated that detailed header information will not be necessary as the PMC 110 may commonly communicate with an outside device that is dedicated to the system incorporating the PMC 110, as described below and in the priority application titled Systems and Methods for Wirelessly Receiving Computer System Diagnostics Information. Therefore, the communications scheme greatly reduces the total amount of information that must be transmitted for each communication.

Unlike standard data encryption mechanisms that rely on polynomial equations, parity bits, and other schemes that utilize separate bits to represent checksum information, the present communications encryption mechanism utilizes a repeated message with certain inherently-valid patterns and certain inherently-invalid patterns. A receiver receiving the message checks to determine whether a valid pattern has been received, and discards communications having invalid patterns. Because the message is repeated, the orientation between the transmitter and receiver can be changed until a good signal is obtained and the communication is properly received without discarding invalid information.

In a specific scheme used with embodiments of the present invention, valid patterns exist in four- and eight-bit sequences, which are separated by three-bit gaps. The receiver then looks for a valid four-bit sequence followed by a three-bit gap, which signals the start of the transmission. After the start-signaling four-bit sequence and three-bit gap, one or more eight-bit sequences are transmitted and received, with the eight-bit sequences containing the data of the message to be conveyed by the PMC 110.

In at least some instances, the four-bit header serves two purposes besides conveying a valid start to the message. One purpose is conveying the content of the following message, such as post codes, error codes, etc., with one of up to four types of messages being conveyed by two bits of the header. The second purpose is to act as a counter as the message is repeated up to four times by the PMC 110 using the IR transmitter 124. The counter function allows the receiving device to determine a quality of the wireless communication environment and link (such as while the user positions the receiving device)—if the receiving device correctly receives the entire transmission on the first repetition, it is receiving the transmission well. Where two-way communication is available and good reception has been obtained, some embodiments may allow the receiving device to communicate to that effect to the PMC 110, whereupon future messages in the session will only be repeated twice. In contrast, if the receiving device only receives the full transmission on a later transmission or not at all, it may communicate to the user that the signal is weak and that it may be advantageous to reposition the device.

Clocks between the two devices may be synched in two fashions. First, as the receiving device receives a valid four-bit header it naturally receives clock information from the header. Second, the IR transmitter 124 does not simply pulse on and off, but each on “pulse” may actually be formed from a series (e.g. ten) micro-pulses at a certain frequency. The IR transmitter 124 of certain embodiments transmits at a flash frequency of approximately 32,768 Hz. The receiver detects the pulses at this or a very-close frequency (e.g. at 33 kHz) and uses detection of a ten-flash pulse to set its own clock accordingly with each ten-flash pulse. The micro-flash pulse also assists the receiving device to distinguish the IR signal from background IR noise.

In manners similar to those discussed herein, a communications protocol is provided whereby separate checksum data is eliminated and the data stream contains strictly data payload that can be validated upon reception.

The combination of the enhanced monitoring and logging capabilities of the PMC and the communications capabilities of the PMC greatly enhance the facility of diagnostics and repair of computer systems incorporating the PMC. As discussed below and in the priority application for wireless diagnostic devices, a wide variety of diagnostic communications may be provided to an external diagnostic device. The communications may be tailored to the abilities and skills of the person using the diagnostic device, such that a less-skilled person may be provided with a simple message that a fault has occurred and the computer device requires skilled service, while a more-skilled person may be instructed to replace a certain circuit board, and a highly-skilled person may be instructed that a certain power supply has failed. As what message is displayed by the diagnostics device may be tailored by the diagnostics device based on programming contained therein, a fuller description is left to the section below.

Thus, embodiments of the invention provide systems and methods for intelligent and flexible management and monitoring of computer systems using logic-gate based platform management controllers (PMCs) located on circuit boards of a computer system. The PMCs provide for enhanced circuit board certification and security, enhanced systems monitoring and reporting, and enhanced systems control. The PMCs also allow for emulation of processor-based devices and are low-power, low-cost and very fast when compared to the devices replaced and functionality provided. Other benefits and features of the various embodiments of the invention have been described herein and/or are set forth in the claims.

### Power Management

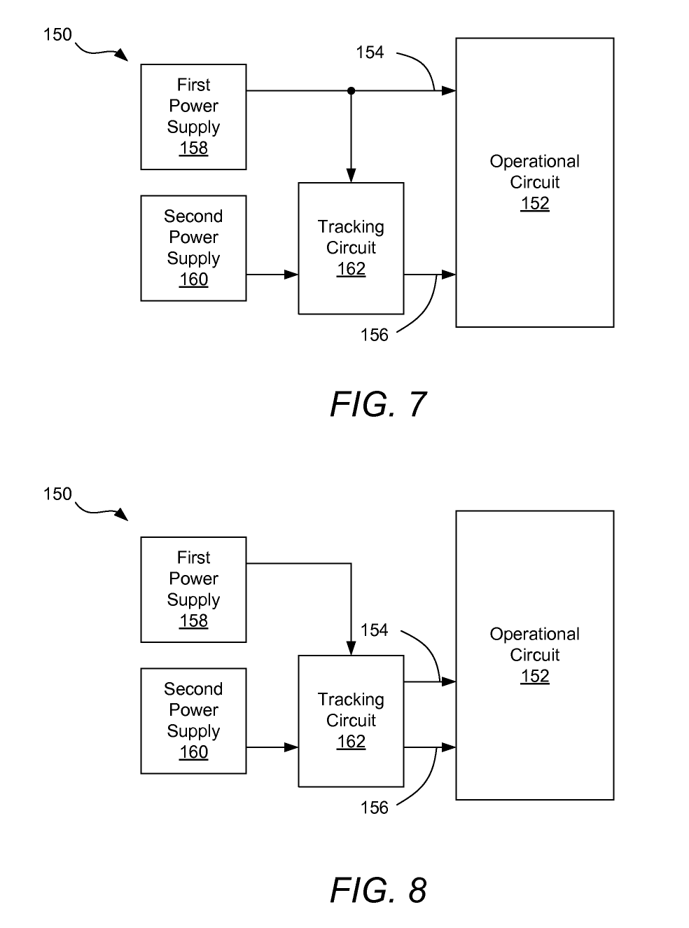

As discussed above under the heading “Platform Management,” some embodiments of the invention incorporate intelligent power management control. Such control may include the intelligent activation and deactivation of power supplies within an electronic system such as a computer system described above under the heading “Representative Computer Systems.” FIGS. 7-13 and the accompanying discussion are intended to explain certain representative methods and systems for providing power management, although other methods and systems are embraced by embodiments of the invention.

Turning first to FIG. 7, an electronic system is illustrated in which some embodiments of the invention can advantageously be employed. The electronic system, shown generally at 150, includes an operational circuit 152. For example, the operational circuit is a computer system or portion thereof and includes or comprises one or more integrated circuits. The operational circuit 152 has a plurality of power inputs, such as for example, a first power input 154 and a second power input 156. The operational circuit 152 has constraints or rules which limit the relative voltages that are presented at the first power input 154 and the second power input 156.

The electronic system 150 includes a plurality of power supplies such as, for example, a first power supply 158 and a second power supply 160. The power supplies provide electrical power to the operational circuit 152, as explained in further detail below. The power supplies are, for example, linear power supplies or switching power supplies. While the electronic system 150 is illustrated as though each power supply provides a single discrete output voltage, it is to be understood that multiple voltage output power supplies are also within the scope of the present invention. For example, the first power supply 158 and the second power supply 160 may be a single power supply which provides two different output voltages.

A tracking circuit 162 is coupled to the power supplies 158, 160 and the operational circuit 152 to moderate the power supplied to at least one of the power inputs 154, 156 of the operational circuit 152. For example, in the embodiment illustrated in FIG. 7, the tracking circuit 162 moderates the power supplied to the power input 156 only. The tracking circuit 162 functions to ensure that the power supplied to the power inputs 154, 156 follows the constraints imposed by the operational circuit 152. For example, constraints can include, but are not limited, to the following examples:

V1>V2

V1<a predefined maximum voltage

V2<a predefined maximum voltage

V1−V2<X, wherein X is a predefined quantity

where V1 is the voltage at the first power input 154 and V2 is the voltage at the second power input 156.

With more than two power inputs, similar constraints can be present which relate three or more different voltages, including but not limited to the following three-voltage examples:

V1>V2>V3

V1<V2<V3

V1−V3<Y and V1−V2<X, wherein X and Y are predefined quantities.

Embodiments of the present invention are not limited to the foregoing examples, and other constrains which can be accommodated by embodiments of the present invention can also be included or utilized. The number of constraints imposed on a system may increase to at least some extent based on the number of power supplies (or discrete voltages supplied by multi-voltage power supplies) utilized by the system.

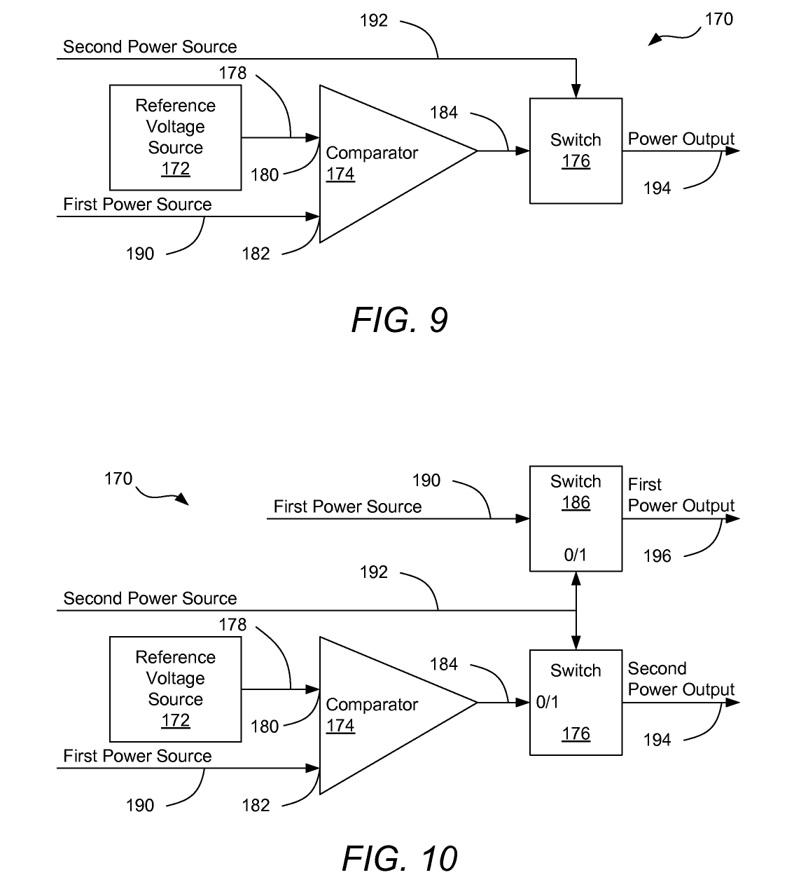

While the system illustrated in FIG. 7 shows a configuration moderating power supplied to a single power input 156 of the operational circuit 152, FIG. 8 shows an alternate configuration that moderates power supplied to all of the power inputs 154, 156 of the operational circuit 152. For example, while the electronic system 150 illustrated in FIG. 7 includes the first power supply 158 directly connected to the first power input 154, the electronic system 150 illustrated in FIG. 8 shows that the first power supply 158 is connected to the first power input 154 only through the tracking circuit 162. The first power supply 158 supplies input power to the tracking circuit 162 in both instances, but in FIG. 8 the tracking circuit 162 can prevent the delivery of power from the first power supply 158 to the first power input 154 when any constraints are violated. FIGS. 9 and 10 illustrate tracking circuits that may be used in each of these embodiments.

Turning to FIG. 9, one example of a tracking circuit is illustrated which ensures that constraints of the form V1>V2 and V1−V2<X are maintained. The tracking circuit, shown generally at 170, includes a reference voltage source 172, a comparator 174, and a switch 176. The reference voltage source provides a reference voltage 178 which is provided to a first input 180 of the comparator 174. The reference voltage source 172 is, for example, a resistor divider network, a voltage reference device, a reverse biased zener diode, or similar device capable of generating a predetermined voltage. The predetermined voltage is set to some value less than X. Coupled to a second input 182 of the comparator 174 is a first power source 190 which is an input to the tracking circuit 170. For example, the first power source 190 is or is coupled to the first power supply 158 and first power input 154 of FIG. 7.

The comparator 174 provides an output 184 which switches between a first state and a second state as a function of the relative voltage at the inputs 180, 182. For example, when the second input 182 (e.g. from first power source 190) is higher than the reference voltage 178 at the first input 180, the comparator output 184 switches from a low output to a high output. Various types of comparators can be used, including for example, an operational amplifier, comparator chips, and the like.

The comparator output 184 controls the switch 176, and thus controls when a second power source 192 is connected to a power output 194. The second power source 192 is an input to the tracking circuit 170. For example, the second power source 192 is or is connected to the second power supply 158 of FIG. 7. The power output 194 is an output from the tracking circuit 170, and is, for example, connected to the second power input 156 of the operational circuit 152 of FIG. 7. Various types of switches can be used, including for example, a bipolar transistor, a field effect transistor (e.g., a MOSFET), a relay, and the like.

Representative operation can be as follows. During power up, the first power source 190 and second power source 194 can both be expected to ramp up. Initially, the switch 176 can be held open by the comparator 174. Hence, the power output 194 can be disconnected from the second power source 192. This can ensure that the power output 194 (e.g., second power input 156) voltage is held less than the voltage of the first power source 190 (e.g., first power input 154), satisfying the constraints of the operational circuit 152. Once the first power source 190 has ramped up to a voltage equal or greater than the predefined value X, the comparator 174 can switch state, closing the switch 176. This can connect the power output 194 to the second power source 192. The power output 194 (e.g., second power input 156) can also begin to ramp up, thus ensuring that the voltage of the power output 194 (e.g., second power input 156) is not more than X volts less than the voltage of the first power source 190.

During power down, the process can operate in reverse. As the supplies begin to ramp down, the comparator 174 can switch state when the first power source 190 drops below the predefined value, disconnecting the power output 194 (e.g., second power input 156) from the second power source 192 (e.g., second power supply 160).

Note that this circuit can also operate properly if the first power supply 158 fails during operation. In such a case, the comparator 174 can open the switch 176 disconnecting the power output 194 from the second power source 192. Accordingly, the tracking circuit 170 can have the effect of causing the second power input 156 to track up and down with the first power input 154.

While FIG. 9 illustrates the tracking circuit 170 in relation to a system providing management of a single power input to the operational circuit 152 as illustrated in FIG. 7, FIG. 10 illustrates an alternative embodiment providing management of multiple power inputs to the operational circuit and the relationships therebetween, as illustrated in FIG. 8. In this embodiment, the first power source 190 (e.g. first power supply 158) is not directly coupled to the operational circuit 152. Instead, a connection between the first power source 190 and the operational circuit 152 (e.g. first power input 154) is moderated by the tracking circuit 170. This allows the tracking circuit 170 to respond to a case where the first power source 190 should be decoupled from the first power input 154 upon failure of the second power source 192, so as to ensure that a constraint relating to the maximum difference between the first power input 154 and the second power input 156 is not violated upon failure of the second power source 192.

Therefore, as illustrated in FIG. 10, the power output 194 can be considered the second power output of the tracking circuit 170 (e.g. the power output connected to the second power input 156), and a first power output 196 (connected to the first power input 154) is provided. The power output 194 is still connected to the switch 176 as described above, and retains its identical functionality. However, a second switch 186 is interposed between the first power source 190 and the first power output 196 to moderate the power at the first power output 196. The switch 186 may be controlled in this case directly by the second power source 192 such that upon failure of the second power source 192, the switch 186 disconnects the first power source 190 from the first power output 196. Of course, the configuration shown in FIG. 10 is only one way to provide control over connection of two power supplies to two inputs, and should be considered merely illustrative of concepts associated with embodiments of the invention.

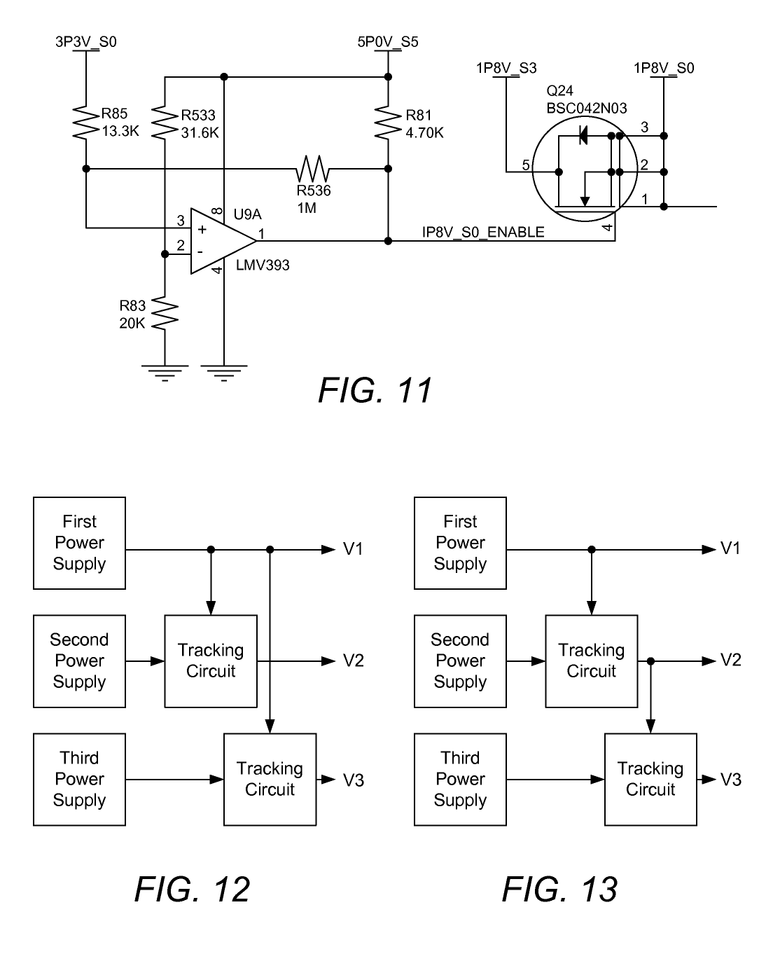

FIG. 11 provides a electric component schematic of an example implementation of an embodiment of a tracking circuit. The tracking circuit provides tracking of a 1.8 V power supply based on a 3.3 V power supply. The tracking circuit is operated from a separate 5 V power supply.

A resistor voltage divider composed of R533 and R83 provides a reference voltage at input pin 2 of the comparator U9A. For this example, using a 5V power supply (5P0V_S5) to power the voltage divider results in a reference voltage of 1.94V. The voltage divider can be powered from other sources, including for example the 3.3V or 1.8V supply which will provide differing performance and thus enforce different constraints.

The 3.3V input is provided through a resistor R85 to input pin 3 of the comparator, which in combination with positive feedback resistor R536, provides a small amount of hysteresis to the comparator U9A. Thus, when the power is ramping up, and the 3.3V supply exceeds 1.96376 volts, the comparator U9A can assert (logic high, or approximately 5 volts) the 1.8 v power supply enable signal (1P8V_S0_ENABLE). Conversely, when power is ramping down, and the 3.3V supply drops below 1.89745 volts, the comparator can de-assert (logic low or approximately 0V) the 1.8V power supply enable signal. The comparison is thus to two different predefined voltages, using a first predefined voltage to control switching during ramping up and a second predefined voltage to control switching during ramping down. This example illustrates how the tracking circuit can thus provide additional margin in meeting a constraint on the relative voltages, or alternatively enforce different constraints which apply during power up and power down.

A MOSFET Q24 provides the switching function, and is controlled by the comparator output (1P8V_S0_ENABLE). The MOSFET, when switched on, allows the 1.8V output (1P8V_S0) to be supplied from the 1.8V power supply (1P8V_S3).

If desired, multiple tracking circuits can be coupled together. For example, in a system with 3 three different voltages, two tracking circuits can be supplied to allow a second V2 and third V3 voltage to track a first voltage V1. In some embodiments, the tracking circuits can each be connected in a parallel arrangement, so that V2 tracks V1 and V3 tracks V1. In other embodiments, the tracking circuits can be connected in series arrangement so that V2 tracks V1, and V3 tracks V2. For example, FIG. 12 illustrates a parallel arrangement, in which voltage V2 is controlled based on voltage V1, and V3 is also controlled based on voltage V1. Thus, constraints which relate V2 to V1 and constraints which relate V3 to V1 can be enforced. FIG. 13 illustrates a series arrangement of tracking circuits, in which voltage V2 is controlled based on voltage V1, and V3 is controlled based on V2. Thus, constraints which relate V2 to V1 and constraints which relate V3 to V2 can be enforced. Combinations of parallel and series arrangements can also be used, allowing more complex constraints to be enforced.

As will now be appreciated, tracking circuits in accordance with the present disclosure can help to ensure that power supply voltages provided to an operational device maintain relative voltages necessary to meet the requirements of the devices. The tracking circuit or circuits help to maintain proper relative voltages during power up and power down. In addition, the tracking circuit or circuits help to maintain proper relative voltages when a power supply fails. Moreover, the tracking circuit or circuits protects components.

These illustrations are merely representative of the capabilities of one or more modular tracking circuits units in accordance with embodiments of the present invention. Indeed, while illustrative embodiments of the invention have been described herein, the present invention is not limited to the various embodiments described herein, but rather includes any and all embodiments having modifications, omissions, combinations (e.g., of aspects across various embodiments), adaptations and/or alterations as would be appreciated by those in the art based on the present disclosure. The limitations in the claims are to be interpreted broadly based the language employed in the claims and not limited to examples described in the present specification or during the prosecution of the application, which examples are to be construed as non-exclusive.

### Wireless Diagnostics

As discussed above and disclosed the priority application titled “Systems and Methods for Intelligent and Flexible Management and Monitoring of Computer Systems,” a wide variety of information that may be useful for diagnostic information may be recorded and logged by a platform management controller (PMC) or similar device integrated into the target device or computer system from which diagnostics information is desired. Such information can be quite varied, and discussion above includes an exemplary, but non-exhaustive set of the type of information that can be recorded by the PMC. By way of example only, and not limitation, the information that may be recorded and then transmitted to a diagnostic device includes post code data, failure data, temperature data, all information drawn from one or more computer busses such as a low pin count (LPC) bus or an inter-integrated circuit (I²C) bus, operating system (OS) messages, basic input/output system (BIOS) messages, sideband management information, and the like. The discussion above discloses systems and methods for obtaining, logging, and transmitting this information to external diagnostic devices.

As discussed above, some embodiments of the invention utilize infrared (IR) transmission schemes between the target device and the diagnostic device. Although a wide variety of IR transmission and communication schemes may be used, some embodiments of the invention use select schemes that provide information and data that inherently carries checksum or validity information without requiring separate checksum or validity bits. The infrared communications scheme also includes clock information. In many instances, it is anticipated that detailed header information will not be necessary as the diagnostic device will commonly be used in direct communications with the target devices. For all these reasons, the communications scheme greatly reduces the total amount of information that must be transmitted for each communication. In manners similar to those discussed above, a communications protocol is provided whereby separate checksum data is eliminated and the data stream contains strictly data payload that can be validated upon reception.

The combination of the enhanced monitoring and logging capabilities of the PMC and the communications capabilities of the PMC greatly enhance the facility of diagnostics and repair of computer systems incorporating the PMC. A wide variety of diagnostic communications may be provided to an external diagnostic device. The communications may be tailored to the abilities and skills of the person using the diagnostic device, such that a less-skilled person may be provided with a simple message that a fault has occurred and that the computer device requires skilled service, while a more-skilled person may be instructed to replace a certain circuit board, and a highly-skilled person may be instructed that a certain power supply has failed. A determination may be made as to what message is displayed by the diagnostics device and may be tailored by the diagnostics device based on programming contained therein is described in more detail below.

As with the PMC devices discussed above, the functions of the diagnostic device may be provided largely to entirely by a logic gate chip, such as a chip containing one million logic gates. Of course, it will be understood that where less functionality is required, smaller chips may be used, and where greater functionality is desired, larger chips may be used. Implementing the functionality in logic provides a variety of advantages. First, the logic chip is able to process a variety of tasks simultaneously and in parallel, and does so with considerable power savings over microprocessor-based devices. Additionally, when different functionality is desired, the logic chip may be readily reprogrammed to provide different or additional functionality. As the device uses logic to encode and decode data and lookups, it operates in real time and does not need a microprocessor or other device running code to decide how to act on the received data.

In at least some embodiments, a variety of display screens may be provided for different models of diagnostic devices based on the anticipated information that will be displayed. If only limited information is to be displayed, a small display screen may be provided, and if greater information is to be displayed, a larger display screen may be provided, etc. The logic-chip and screen features allow a single device to be reprogrammed and refitted with a different screen to perform different tasks with relative ease. Similarly, certain embodiments may include a variety of input devices, such as a variety of different keypads and the like. Thus, embodiments of the invention embrace the use of over-designed units that are field upgradable, customizable, and software configurable.

Embodiments of the external diagnostic unit receive information from their target devices wirelessly (e.g. by IR). This permits great flexibility in receiving diagnostic information without having to physically connect to the target device. Thus, embodiments of the invention may be used to readily and flexibly conduct diagnosis in a wide variety of circumstances.

As one example, a wireless diagnosis device in accordance with embodiments of the invention may be placed in an assembly line at a manufacturing plant of the target devices. As each target device arrives at the station of the diagnostic device, it is powered on and information as to whether it powered on correctly and detailed information regarding any failures is wirelessly transmitted to the diagnostic device. Because the diagnostic device need not be physically connected to the target device, assembly-line diagnosis and removal of faulty systems is facilitated at increased speeds and lowered complexity. Additionally, because of the great detail of information that can be received by the diagnosis device, troubleshooting and repair of non-functioning target devices can be more easily accomplished.

The target devices can be a wide variety of computer systems and embedded devices, including any of those discussed above under the heading “Representative Computer Systems.” As will be appreciated, diagnosis of such devices often continues after the point of manufacture, as normal failures due to use and non-standard failure for a variety of other causes occur. When target devices require service for some sort of failure, it is desirable to communicate information to a servicing technician that will aid the technician in addressing the problem. A difficulty arises, however, in that not all servicing technicians have equal skill levels. For example, one target device owner/technician may have little to no skill in how to address system problems, while a second may have sufficient knowledge to, say, replace a faulty circuit board. Still another technician may have sufficient skill to replace an individual faulty component on a circuit board. Embodiments of the invention allow flexible customization of the information displayed by the diagnostics device so as to be appropriate for the skill level of the individual user.

As discussed above, the PMC or similar component of the target device records a variety of information and transmits it to the diagnostic device, which receives and interprets the information. As one example, the information received may indicate that a certain power supply on one circuit board of the target device has failed. While this information is detailed, and allows a skilled technician to replace the specific power supply without replacing the entire circuit board, not all individuals are so skilled. Therefore, if the diagnostic device is used by a less-skilled user, the diagnostic device may be configured to display a variety of messages to different users. When the diagnostic device is to be used by a skilled technician, the device may be configured to receive the power supply failure information and display the specific failure. When the diagnostic device is to be used by a less-skilled technician, the device may be configured to receive the same power supply failure information, but may be configured to display instead that a failure has occurred with a certain circuit board that should be replaced. Finally, when the diagnostic device is to be used by a layman, the device may be configured to receive the same power supply failure information, but may be configured simply to display that an unrecoverable fault has occurred and the target device should be replaced or serviced. In each instance, the physical structure of the diagnostic device may be identical (with a possible exception of screen size), but the different functionality provided by reconfiguring the functionality provided by the logic chip. Alternatively, devices having further differences (e.g. devices having differing amounts of logic gates and/or capabilities) may be provided to different users.

In similar fashion, the diagnostic device remains useful over time even as changes and improvements occur to the target devices. Simple changes and additions to software modules implemented in the logic chip allow the diagnostic device to continue to be used and to provide new functionality for future devices. Modules may be removed and added as desired for different users, different uses, etc. Thus, a single diagnostic device could be configured and leased to one party to meet that party's needs and then reconfigured and re-leased to a different party having different diagnostic needs.

The diagnostic device can be used to measure system health as well as a variety of customer-specified information such as information obtained by the target device. For example, the target device's OS may be used to obtain data in an embedded system. The OS may then be instructed to transmit the obtained data using the PMC or similar device. In this example, the diagnostic device may have been configured to ignore all information other than OS messages, and then receives and stores the information transmitted by the OS (the obtained data). This is merely one example of the flexibility provided by embodiments of the diagnostic device. Information may be received from a variety of layers, including hardware layers, OS layers, and BIOS layers.

As mentioned above, embodiments of the diagnostic device may be useful in a wide variety of stages of manufacture and use of the target devices. They may be useful for manufacturers in the manufacturing stage to detect manufacturing defects and non-functioning systems. The diagnostic devices may be useful for data collection at the target devices (e.g. for embedded devices). The diagnostic devices may also be useful for on-site repair purposes and off-site (e.g. repair depot) purposes. Because of the level of detail transmitted by the PMC and received by the diagnostic device, diagnosis and repair times and repair efficiencies at all stages of the target device lifetime are significantly improved using embodiments of the invention.

While certain embodiments of the invention rely on essentially one-way communications transmitted from the target device to the diagnostic device, other embodiments utilize two-way communications. Where two-way communications are used, the diagnostic device can be used to provide instructions to the target device as well as receive information from the target device. For example, if the target device is an electronic billboard controller, the diagnostic device could even be used to upload a new advertisement to the billboard controller.

Embodiments of the invention will prove useful in a wide variety of reporting-type situations, even if systems diagnosis is not necessarily needed. By way of example only, embodiments of the invention may be used for a wide variety of remote data collection. Target devices may be embedded in remote locations and may collect a wide variety of data. From time to time, a user of a diagnostic device may visit the remote target devices and collect the recorded data. In at least some instances, it may be sufficient to simply reach the vicinity of the target device and point the diagnostic device at the target device to receive the information.

As another example, a diagnostic device may be used by a security guard or other person performing a certain route. Target devices may be embedded at certain stops on the route, and the diagnostic device used to record that each target device was visited. At the end of the route, information from the diagnostic device may be downloaded and used to show that the route was taken as required and the timing thereof.

In another example, a target device may be provided at a remote dispensing location of some sort of consumable such as water, gas, etc. where it is not feasible to provide a person to dispense the consumable. For example, a cement truck travelling long distances from the plant may make most of the trip with dry concrete, and then stop at a water source to wet the concrete. If the water is to be paid for, the driver must log how much water was used. Embodiments of the invention make this task simple, as a system embedded at the water source records the amount of water used, and transmits the information to a diagnostic device of the driver or cement truck, and the information is retrieved from the diagnostic device at a later time for billing purposes.

The foregoing examples are merely examples of possible uses of embodiments of diagnostic devices as described herein.

### Physical Connections for Diagnosis and Management

While certain embodiments of the invention embrace obtaining information from electrical systems such as computer systems using wireless systems and communications as discussed above, some embodiments of the invention embrace obtaining information from such systems using physical connections. The use of wireless connections between systems is not exclusive of the use of physical connections between systems and the use of physical connections is not exclusive of the use of wireless connections between systems.

Some embodiments of the present invention take place in association with temporary electrical connections between an external source and a PCB to facilitate the transfer of data across the connection. In at least one embodiment, a temporary electrical system includes a PCB having electrical contact pads disposed adjacent one or more edges of the PCB. The electrical contact pads in turn are electrically connected to particular locations on the PCB. The systems further include a temporary electrical connector apparatus which in turn includes an electrical wire ribbon and a head at the distal end of the electrical wire ribbon having one or more electrical contact pads disposed thereon that correspond to the electrical pads disposed on the edge(s) of the PCB.

In some embodiments, an apparatus adapted to temporarily electrically connect with a PCB includes an electrical wire ribbon. The apparatus further includes a head at the distal end of the electrical wire ribbon having one or more electrical contact pads disposed thereon. In some embodiments, the head also has an adhesive disposed on it, which substantially surrounds the electrical contact pads. Prior to use, the adhesive is protected by a non-stick paper backing or the like, which can be removed upon use. In another embodiment, the head includes a compression fitting that can be manipulated to tension the head such that it temporarily remains fixed to a corresponding surface, such as a PCB. In yet another embodiment, the head includes pins or other physical location devices that that can be used to facilitate a correct temporary connection between the head and a corresponding surface, such as a PCB. In still another embodiment, the head is comprised of two opposing jaws connected by an operable spring which biases the jaws in a closed position such that the jaws can be selectively opened by a user and the head temporary “clipped” to a corresponding surface, such as a PCB. In yet another embodiment, the head is comprised of two stationary surfaces connectively separated the width of a PCB such that the head can be temporarily slipped over the edge of the PCB to remain temporarily affixed thereto.

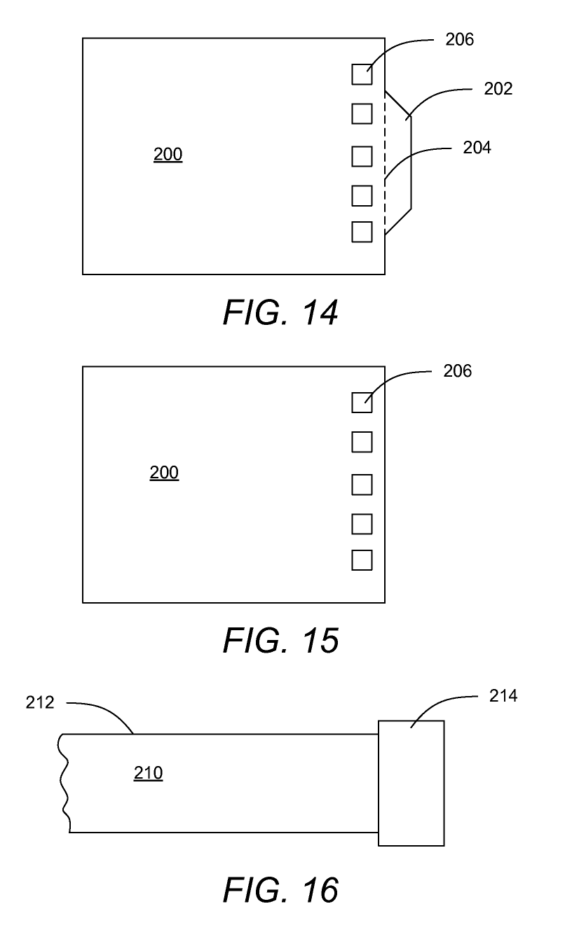

With reference now to FIG. 14, a representative PCB 200 is illustrated. For purposes of simplifying this disclosure, the various physical features and elements of a typical PCB common to those known to persons of skill in the art are neither shown nor discussed. This is not intended to be limiting in any way, rather, it is intended merely to permit a focused discussion of the features of some embodiments the present invention. As illustrated in FIG. 14, during the production process PCB 200 includes “break-off” or removable tab 202. Tab 202 is connected to PCB 200 at dashed line 204 to illustrate that tab 202 is removable. By means of tab 202, the PCB can be programmed and/or debugged via hardware debug tool (HDT) devices. Following production, however, tab 202 is snapped off or otherwise removed along dashed line 204 as depicted in FIG. 15.

As further illustrated in FIGS. 14 and 15, a representative embodiment of the PCB 200 contemplated by embodiments of the present invention includes electrical contact pads 206. Electrical contact pads 206 can be comprised of any suitable conductive material common to PCB construction and known in the art such as copper, gold, alloys thereof, and any other conductive materials or composition materials. Electrical contact pads 206 can be connected to any desired element or location of the PCB 200 via electrical circuitry (not show) built into PCB 200. By such means electrical signals and information can be transmitted from pads 206 to any location or element of the PCB 200 such that the PCB 200 can be programmed, debugged, or otherwise communicated with for any desired purpose.

While in some embodiments, electrical contact pads 206 are located substantially on one edge of PCB 200 as shown, embodiments of the present invention embrace locating electrical contact pads 206 at any suitable location along any of the edges of a PCB 200, including each edge as necessary or desired. Further, in some embodiments, PCBs 200 contemplated by embodiments of the present invention can have different shapes other than four sided shapes as shown in FIGS. 14 and 15. In such embodiments electrical contact pads 206 can be located along any number of such edges. In addition, while electrical contact pads 206 are depicted as being located on one major surface of the PCB 200, electrical contact pads 206 may be located on both major surfaces (i.e. “top” and “bottom”) of the PCB 200 simultaneously. Pads 206 have a low profile and thus locating them on both the top and bottom of the PCB 200 does not interfere with other functionality or with placement of PCB 200.

Similarly, as illustrated in FIGS. 14 and 15, PCB 200 can include a discrete number of pads 206. In some embodiments, PCB 200 can include as few as one pad while in other embodiments a number of pads 206 as great as the surface area of PCB 200 will allow are contemplated. In still other embodiments pads 206 can be discrete and independent or the pads 206 can be connected. In yet other embodiments, PCB 200 can include a combination of discrete pads 206 and connected pads 206. While pads 206 are depicted as having a certain size, shape or configuration, this is for illustration purposes only and is not intended to be limiting in any way or necessarily drawn according to scale. Indeed, pads 206 can any size, shape or configuration desired. Further, while pads 206 are illustrated as only extending one row deep from the edge of the PCB 200, multiple rows, levels or layers of pads are embraced by embodiments of the present invention.

With reference to FIG. 16, a distal end of a representative embodiment of a temporary electrical connection device or apparatus 210 is illustrated in plan view as seen from above. As illustrated, electrical connection apparatus 210 includes flat electrical wire ribbon 212 and head 214. Head 214 is located at the distal end of ribbon 212. An external device (not shown) that a user desires to connect to PCB 200 for any purpose is located at the proximal end of ribbon 212, and may be directly connected to the ribbon 212 or may be connected to the ribbon 212 via a connector of any desirable type. Alternatively, the external device and the head 214 may be integrated into a single unit and not be separated and connected by an exposed wire ribbon 212 or other external wire connection. The external device can be any device suitable for programming, debugging, transferring data back and forth between the external device and PCB 200 or otherwise communicating with PCB 200 for any desired purpose and to transmit any desired type or format of data, which may include a diagnostic device similar to the wireless diagnostic device discussed above under the heading “Wireless Diagnostics,” or any other device.

Such data may also include, but is not limited to, Joint Test Action Group (JTAG) debugging data as well as other CPU diagnosis data similar to that typical of data transfers on a CPU diagnosis port. However, the data is not limited to debugging operations. Rather, any electronic data can be transmitted, including video, audio, programming, and/or any other type of desirable electronic data. As with PCB 200, the dimensions, shapes and sizes of the apparatus depicted in FIG. 16 or any of the subsequent Figures are not intended to be necessarily to scale. Indeed, ribbon 212 and head 214 may be any suitable size, shape or configuration suitable for practicing the invention.

Turning to FIG. 17, a representative embodiment of a temporary electrical connection device or apparatus 210 (similar to apparatus 210 discussed with respect to FIG. 16) is illustrated in plan view from the underside. In the illustrated embodiment, apparatus 210 includes wire ribbon 212 and head 214 similar to ribbon 212 and 214 generally discussed above with reference to FIG. 16. In addition, head 214 includes electrical contact pads 216 disposed on the underside of the head 214. The “topside” of head 214 previously referred may be understood to denote the side of the head facing away from the PCB 200 during operation. The “underside,” on the other hand, faces the PCB 200 to permit the pads 216 to contact the pads 206. The terms “topside” and “underside” are for the convenience of discussing the embodiments and illustrations of FIGS. 16-20 and are not intended to be limiting in any sense.

The contact pads 216, and subsequent contact pads 216 discussed in reference to other embodiments below, may be constructed of any material suitable in the art (as discussed in greater detail above with reference to pads 206 of PCB 200) and are electronically connected with wiring housed or encased in ribbon 202 such that electrical signals can be transmitted via such wiring and pads 216. Further, as discussed with greater detail in reference to FIGS. 14-15 and contact pads 206 of PCB 200, contact pads 216 may be disposed in any suitable location, be any size, be any shape, be situated in any suitable configuration, be a single row/level/layer deep or multiple rows/levels/layers deep and otherwise be oriented and dimensioned in any suitable fashion for practicing embodiments of the instant invention.

In some embodiments, head 204a also includes removable adhesive 218. Adhesive 218 can be disposed on the underside of head 214 around and adjacent to electrical contact pads 216. Adhesive 218 can be any temporary and removable adhesive available in the industry such as numerous adhesive materials manufactured by 3M among other manufacturers. Prior to use, a non-stick paper backing (not shown) or the like covers adhesive 218. When a user desires to use apparatus 210, the paper backing is simply removed and head 214 is adhered, with the underside facing the PCB 200, to the desired surface of the PCB 200 (i.e. either the top or bottom). During this process, electrical contact pads 216 are located such that they are in electronic communication with electrical contact pads 206.

Locators or other physical location devices or devices to properly locate the head 214 on the PCB 200 can be incorporated into either the PCB 200, the apparatus 210, or both to facilitate such location. In this way, the locators assist in ensuring that apparatus 210 achieves and remains in proper and reliable electrical communication between an external device and PCB 200 for a temporary period of time desired by the user. Further, PCB 200 need not be outfitted with connectors or ports to conveniently accomplish such electrical communication. Accordingly, the external device can communicate with PCB 200 as discussed in greater detail above.

When the desired communication between an external device and PCB 200 is completed, the user can simply peel head 214 and removable adhesive 218 off of the PCB 200. Apparatus 210 can be constructed of disposable materials such that it can simply be discarded at this point. Alternatively, if the removable adhesive 218 sufficiently retains its adhesive properties, the non-stick paper backing or the like can be replaced such that apparatus 210 can be re-used again in a similar fashion subsequently, or the apparatus 210 can be re-used again immediately without replacing the paper backing or the like. This process can be repeated as often as desired until adhesive 218 no longer exhibits adhesive characteristics or otherwise loses its adhesive properties. At such point, apparatus 210 can simply be discarded. In this way, a user can temporarily connect to PCB 200 simply and inexpensively with little risk of damaging the PCB 200 or the connection apparatus 210.

With reference to FIGS. 18 through 20, alternative representative embodiments are illustrated. In FIG. 18 a representative embodiment of a temporary electrical connection device or apparatus 210 (similar to apparatus 210 discussed above) is illustrated in plan view from the underside. In the illustrated embodiment of FIG. 18, apparatus 210 includes wire ribbon 212 and head 214 (similar to ribbon 212 and head 214 generally discussed above with reference to FIGS. 16 and 17). In addition, head 214 includes electrical contact pads 216 disposed on the underside of the head 214. Thus, in the foregoing and subsequent discussion, various iterations of apparatus 210, ribbon 212, head 214 and pads 216 are discussed.

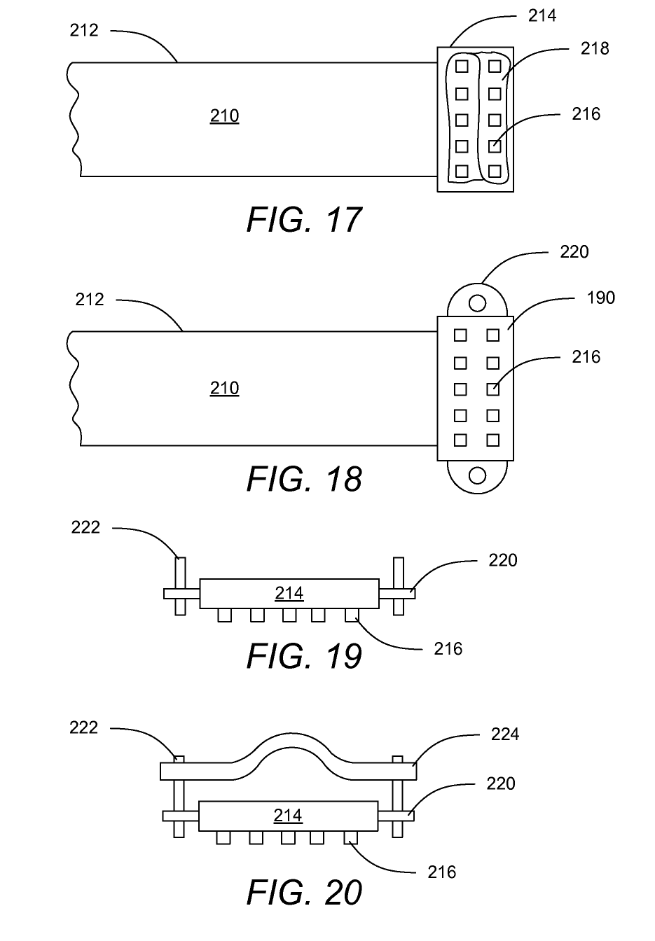

As further shown in FIGS. 18 through 20, head 214 includes locators or tabs 220 on either side of head 214. Tabs 220 can be located in any suitable location and can be any suitable size or shape to facilitate connection of apparatus 210 to PCB 200. Tabs 220 are intended to facilitate locating and attaching head 214 to PCB 200. This is accomplished both visually and via additional hardware. For example, FIG. 19 illustrates locator pins 222 inserted through tabs 220 such that pins 222 can be inserted or otherwise temporarily attached to PCB 200 to both orient head 214 properly and to temporarily secure head 214 to PCB 200. In an alternative embodiment, as shown in FIG. 20, a compression fitting 224 or the like can also be attached to or otherwise incorporated in the hardware of head 214. Compression fitting 224 can be deformed or otherwise manipulated by the user to temporarily secure head 214 to PCB 200. Compression fitting 224 operates by distributing tension derived from deforming the fitting 224 through head 214 and associated hardware such that head 214 remains secured in a specific location.

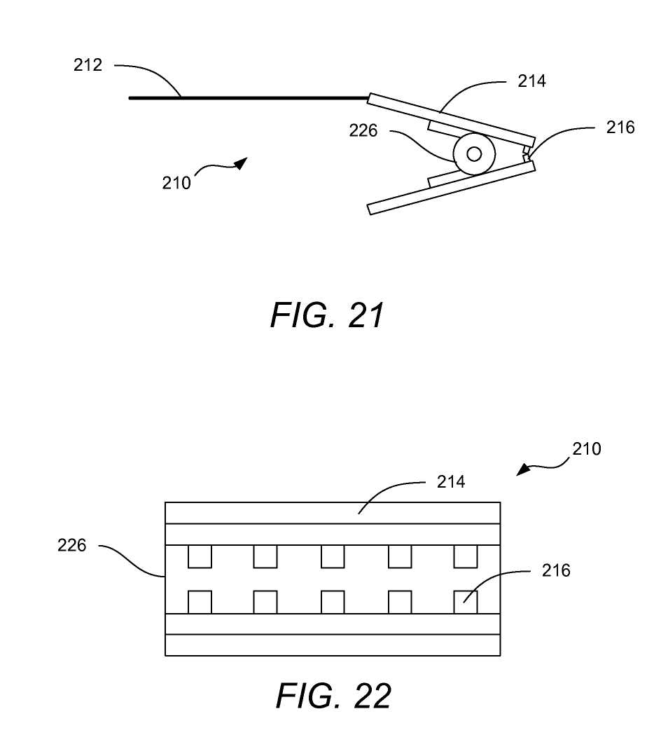

Turning to FIGS. 21 through 22, another alternative representative embodiment is illustrated. In FIG. 21 a side view of a representative embodiment of a temporary electrical connection device or apparatus 210 is illustrated. In the illustrated embodiment, apparatus 210 includes wire ribbon 212, head 214 and electrical contact pads 216 disposed on the jaws of head 214. In addition, head 214 includes a biasing spring 226, which biases the jaws of head 214 into a closed position. Such bias may be overcome by user-applied force denoted by arrows 228. Head 214 also includes electrical contact pads 216 on the interior surfaces of both opposing jaws of head 214 (although in some embodiments, pads 216 are located on only one jaw) such that corresponding pads 206 located on both the top and bottom major surfaces of a PCB 200 may be contacted simultaneously if desired. As discussed in some detail above, however, electrical contact pads 216 can be any size, shape, configuration, orientation, and so forth so as to facilitate operable connection between head 214 and a corresponding PCB 200.

In operation, a user desiring to connect an external device to PCB 200 via apparatus 210 depresses the opposing jaws of head 214 in the direction indicated by arrows 228 to overcome the biasing effect of spring 226 thereby opening the jaws. The head 214 and jaws are subsequently placed relative to the PCB 200 at the desired location of connection. Again, locators on either the head 214 or the PCB 200 can further facilitate the correct attachment of the head 214 to the PCB 200. Once head 214 is properly located, the user releases the force previously applied according to arrows 228 and allows the jaws of head 214 to close on PCB 200. In this way, apparatus 210 remains in reliable electrical communication between an external device and PCB 200 for a temporary period of time desired by the user. Further, PCB 200 need not be outfitted with any external connectors or ports to conveniently accomplish such electrical communication. Accordingly, the external device can communicate with PCB 200 as discussed in greater detail above. When the desired communication between an external device and PCB 200 is completed, the user can re-apply force as indicated by arrows 228 and remove apparatus 210 from the PCB 200. By virtue of biasing spring 226, this process can be repeated as often as desired.

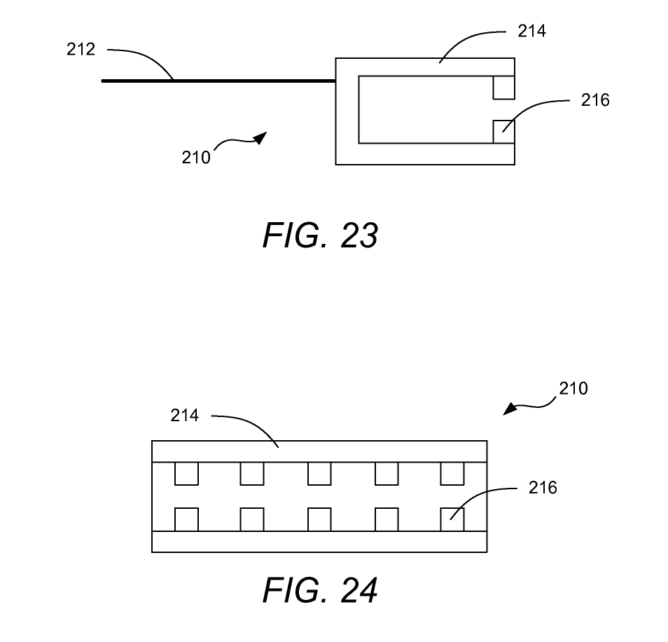

With reference to FIGS. 23 through 24, another alternative representative embodiment is illustrated. In FIG. 23 a side view of a representative embodiment of a temporary electrical connection device or apparatus 210 is illustrated. In the illustrated embodiment, apparatus 210 includes wire ribbon 212, head 214 and electrical contact pads 216 disposed on the fixed opposing surfaces of the head 214 (although the pads 216 may be disposed on only one of the opposing surfaces of the head 214 if desired). The fixed opposing surfaces and corresponding pads 216 of the head 214 are spaced apart such that a PCB 200 having electrical contact pads 206 disposed thereon fits easily but securely between such fixed surfaces. Head 214 also includes electrical contact pads 216 on the interior of both fixed opposing surfaces of head 214 such that corresponding pads located on both the top and bottom major surfaces of a PCB 200 may be contacted simultaneously if desired. As discussed in some detail above, however, electrical contact pads 216 can be any size, shape, configuration, orientation, and so forth so as to facilitate operable connection between the head 214 and a corresponding PCB 200.

In operation, a user desiring to connect an external device to PCB 200 via the apparatus 210 shown in FIGS. 23-24 slips or slides the edge of PCB 200 between the fixed opposing surfaces of head 214 at the desired location of connection. Again, locators can further facilitate the correct alignment of the head 214 with the PCB 200. Once the head 214 is properly located, data can then be reliably transmitted between an external device and PCB 200 for a temporary period of time desired by the user. Accordingly, the external device can communicate with PCB 200 as discussed in greater detail above. When the desired communication between an external device and PCB 200 is completed, the user can slide head 214 off of PCB 200 and remove apparatus 210 from PCB 200. This process can be repeated as often as desired.

Thus, as discussed herein, the embodiments of the present invention embrace temporary physical electrical connections. In particular, some embodiments of the present invention relate to systems and methods for temporarily connecting to a PCB in order to receive or transmit information from or to the PCB.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope. In the claims, means-plus-function or step-plus-function limitations will only be employed where for a specific claim limitation all of the following conditions are present in that limitation: a) “means for” or “step for” is expressly recited; and b) a corresponding function is expressly recited.

What is claimed and desired to be secured by Letters Patent is:

1-47. (canceled)

48. A wireless diagnostics device for monitoring computer system diagnostics information comprising:
a receiver for receiving detailed diagnostics information from a monitored computer device;
a logic gate device communicatively coupled to the receiver and configured to read the received diagnostics information and to determine how to display information regarding a status of the monitored computer system based on the received diagnosis information; and
a display device communicatively coupled to the logic gate device for displaying information sent by the logic gate device.

49. A wireless diagnostic device as recited in claim 48, wherein the logic gate device is configured to direct a display of summary information regarding the status of the monitored computer system that differs in scope and detail from the received diagnostics information.

50. A wireless diagnostic device as recited in claim 49, wherein the logic gate device is customizably configurable to direct a display of varying levels of detail regarding the status of the monitored computer system using the display device.

51. A wireless diagnostic device as recited in claim 48, wherein the logic gate device is configured to direct a display of information directing how to repair an issue with the monitored computer system.

52. A wireless diagnostic device as recited in claim 51, wherein the logic gate device is customizably configurable to direct a display of varying levels of detail regarding actions to take to repair the monitored computer system using the display device.

53. A wireless diagnostics device for monitoring computer system diagnostics information comprising:
a receiver for receiving detailed diagnostics information from a monitored computer device;
a processing device communicatively coupled to the receiver and configured to read the received diagnostics information and to determine how to display information regarding a status of the monitored computer system, wherein the information regarding a status of the monitored computer system differs in scope and detail from the received diagnostics information; and
a display device communicatively coupled to the processing device for displaying information sent by the processing device.

54. A wireless diagnostic device as recited in claim 53, wherein the processing device is a logic gate device.

55. A wireless diagnostic device as recited in claim 53, wherein the logic gate device is customizably configurable to direct a display of varying levels of detail regarding the status of the monitored computer system using the display device.

56. A wireless diagnostic device as recited in claim 53, wherein the processing device is configured to direct a display of information directing how to repair an issue with the monitored computer system.

57. A wireless diagnostic device as recited in claim 56, wherein the processing device is customizably configurable to direct a display of varying levels of detail regarding actions to take to repair the monitored computer system using the display device.

58. A wireless diagnostics device for monitoring computer system diagnostics information comprising:
a receiver for receiving detailed diagnostics information from a monitored computer device;
a processing device communicatively coupled to the receiver and configured to read the received diagnostics information and to determine how to display information directing how to repair an issue with the monitored computer system; and
a display device communicatively coupled to the processing device for displaying information sent by the processing device.

59. A wireless diagnostic device as recited in claim 58, wherein the processing device is configured to direct a display of summary information regarding a status of the monitored computer system that differs in scope and detail from the received diagnostics information.

60. A wireless diagnostic device as recited in claim 59, wherein the processing device is customizably configurable to direct a display of varying levels of detail regarding a status of the monitored computer system using the display device.

61. A wireless diagnostic device as recited in claim 58, wherein the processing device is a logic gate device.

62. A wireless diagnostic device as recited in claim 58, wherein the processing device is customizably configurable to direct a display of varying levels of detail regarding actions to take to repair the monitored computer system using the display device.

63. (canceled)

64. (canceled)
